(19) United States
(12) Patent Application Publication
(10) Pub. No.: US 2018/0281435 A1
(43) Pub. Date: Oct. 4, 2018

(54) LIQUID CONTAINER AND CARTRIDGE

(71) Applicant: BROTHER KOGYO KABUSHIKI KAISHA, Nagoya-shi (JP)

(72) Inventors: Hisaaki YOSHIMOTO, Aichi-ken (JP); Kazuyuki KONDO, Kuwana-shi (JP)

(21) Appl. No.: 15/935,792

(22) Filed: Mar. 26, 2018

(30) Foreign Application Priority Data
Mar. 28, 2017 (JP) 2017-062423

(51) Int. Cl. B41J 2/175; B41J 2/21; B41J 2/14

(52) U.S. Cl. CPC B41J 2/17553; B41J 2/17513; B41J 2/17566; B41J 2002/17576; B41J 2/14201; B41J 2/17523; B41J 2/2103

(57) ABSTRACT

A liquid container includes a storage portion, a stopper, and a plate. The storage portion is a flexible member storing a liquid. The storage portion includes a surface extending in a longitudinal direction and a lateral direction. The longitudinal direction and the lateral direction intersect a predetermined direction. The stopper is provided in a first end portion of the storage portion, of the first end portion and a second end portion that are both end portions in the longitudinal direction of the storage portion. The plate fixed to the surface. At least one of both end portions of the plate in the longitudinal direction includes a protrusion portion. The protrusion portion protrudes in a separating direction, of the longitudinal direction, in which the protrusion portion separates from the storage portion.

### CROSS-REFERENCE TO RELATED APPLICATION

This application claims priority to Japanese Patent Application No. 2017-062423, filed Mar. 28, 2017. The disclosure of the foregoing application is incorporated herein by reference in its entirety.

### BACKGROUND

The present disclosure relates to a liquid container configured to store a liquid, and a cartridge configured to house the liquid container.

There is a liquid container that stores a liquid and a cartridge capable of housing the liquid container. For example, a known ink package is provided with a body that stores ink, and an ink supply opening for supplying the ink. A flat plate is adhered to one side surface portion of the body. The ink cartridge is provided with a sliding member provided on an inner surface side on the side facing the flat plate. The ink package can be mounted on and detached from an ink cartridge by the flat plate being inserted along the sliding member.

### SUMMARY

In the known ink package, the ink supply opening is provided in one end portion in the lengthwise direction of the body. The body has extending portions, which are sections that extend further than the flat plate on both sides in the lengthwise direction. The extending portions extend further than the flat plate on both sides in the lengthwise direction, and it is thus difficult for the flat plate to support the extending portions. As a result, the body easily bends at the extending portions. Specifically, the body easily bends in the lengthwise direction, and there is thus a possibility that handling of the ink package becomes inconvenient.

Various embodiments of the broad principles derived herein provide a liquid container that does not easily bend in a lengthwise direction and a cartridge configured to house the liquid container.

The embodiments herein provide a liquid container that includes a storage portion, a stopper, and a plate. The storage portion is a flexible member storing a liquid. The storage portion includes a surface extending in a longitudinal direction and a lateral direction. The longitudinal direction and the lateral direction intersect a predetermined direction. The stopper is provided in a first end portion of the storage portion, of the first end portion and a second end portion that are both end portions in the longitudinal direction of the storage portion. The plate is fixed to the surface. At least one of both end portions of the plate in the longitudinal direction includes a protrusion portion. The protrusion portion protrudes in a separating direction, of the longitudinal direction, in which the protrusion portion separates from the storage portion.

The embodiments herein also provide a cartridge configured to house the liquid container. The cartridge includes a first tab portion, a second tab portion. The first tab portion is configured to engage with the first convex portion of the liquid container housed in the cartridge. The second tab portion is configured to engage with the second convex portion of the liquid container housed in the cartridge. The at least one of the first tab portion and the second tab portion is configured to elastically deform.

### BRIEF DESCRIPTION OF THE DRAWINGS

Embodiments of the present disclosure will be described below in detail with reference to the accompanying drawings in which:

FIG. 1 is a perspective view of a printer;

FIG. 2 is a left side view of a liquid container;

FIG. 3 is left side view of a plate;

FIG. 4 is a front view of the liquid container;

FIG. 5 is a perspective view of a cartridge seen from above left and from the front;

FIG. 6 is a perspective view of a case seen from above left and from the front;

FIG. 7 is a perspective view of the case seen from below left and from the rear;

FIG. 8 is a perspective view of a lid seen from below right and from the front;

FIG. 9 is a left side view of the cartridge without the lid;

FIG. 10 is a left side view of the cartridge, without the lid, a container, and a plug;

FIG. 11 is a perspective view of the case and the lid in a state of being assembled, as seen from above left and from the front;

FIG. 12 is a perspective view of the cartridge as seen from below left and from the front; and

FIG. 13 is a cross-sectional view of the cartridge as seen in the direction of arrows along a line A-A.

### DETAILED DESCRIPTION

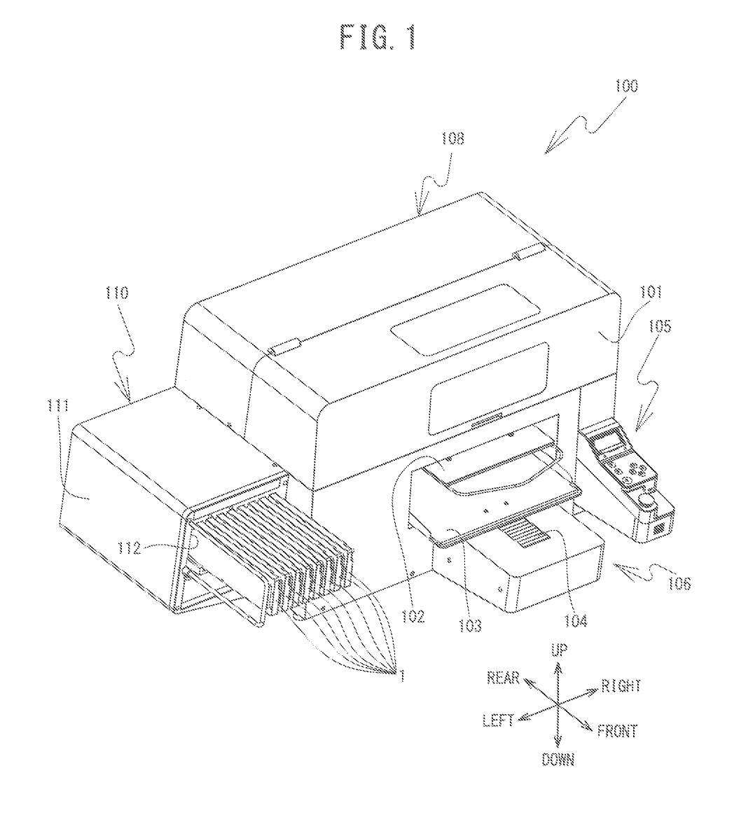

An embodiment of the present disclosure will be explained with reference to the drawings. In the following explanation, the left-right direction, the front-rear direction, and the up-down direction as shown by arrows in the drawings will be used. An outline configuration of a printer 100 will be explained with reference to FIG. 1. The printer 100 is an inkjet printer that performs printing by ejecting ink supplied from a cartridge 1 onto a fabric, such as a T-shirt, that is a print medium. The print medium may be paper or the like. In the following explanation, the upper side, the lower side, the lower right side, the upper left side, the upper right side, and the lower left side in FIG. 1 respectively define the upper side, the lower side, the front side, the rear side, the right side, and the left side of the printer 100.

As shown in FIG. 1, the printer 100 is provided with a substantially cuboid-shaped main body 108, and a substantially cuboid-shaped cartridge mounting unit 110 that is smaller than the main body 108. The main body 108 is a portion that performs printing using print heads (not shown in the drawings) while feeding a fabric, and has a similar configuration to a known inkjet printer used for printing on the fabric. The main body 108 is provided with a housing 101, an operation portion 105, and a platen drive mechanism 106. The operation portion 105 has a display, operation buttons and the like. The platen drive mechanism 106 is provided on a central portion, in the left-right direction, of the main body 108, and includes a platen 102, a tray 103, a drive belt 104, a pair of guide rails (not shown in the drawings), a platen drive motor (not shown in the drawings), and the like.

The drive belt 104 is stretched across pulleys (not shown in the drawings) disposed at the front and the rear of the main body 108. A strut (not shown in the drawings) that is fixed above the drive belt 104 supports the rectangular plate-shaped platen 102 and the tray 103. The fabric is placed on a top surface of the platen 102. The tray 103 is disposed under and substantially in parallel with the platen 102 and is a rectangular plate that is somewhat greater than the platen 102. The tray 103 inhibits a part (a sleeve of the T-shirt or the like) of the fabric placed on the platen 102 from falling down. The pair of guide rails extend in the front-rear direction above the drive belt 104 and guide the platen 102 and the tray 103. The platen drive motor drives the drive belt 104 via the above-mentioned pulleys and thus moves the platen 102 and the tray 103 in the front-rear direction along the pair of guide rails. The platen 102 and the tray 103 enter into and emerge from the housing 101 via an opening in a central portion of the front surface of the housing 101.

The main body 108 is provided with a pair of guide rails (not shown in the drawings) that extend in the left-right direction substantially in the center, in the front-rear direction, inside the housing 101 and above the platen 102. The pair of guide rails support a carriage (not shown in the drawings) of the print heads. The print heads are fixed to a lower portion of the carriage. The printer 100 of the present embodiment has eight of the print heads. A carriage drive mechanism (not shown in the drawings) causes the carriage to move in the left-right direction along the pair of guide rails.

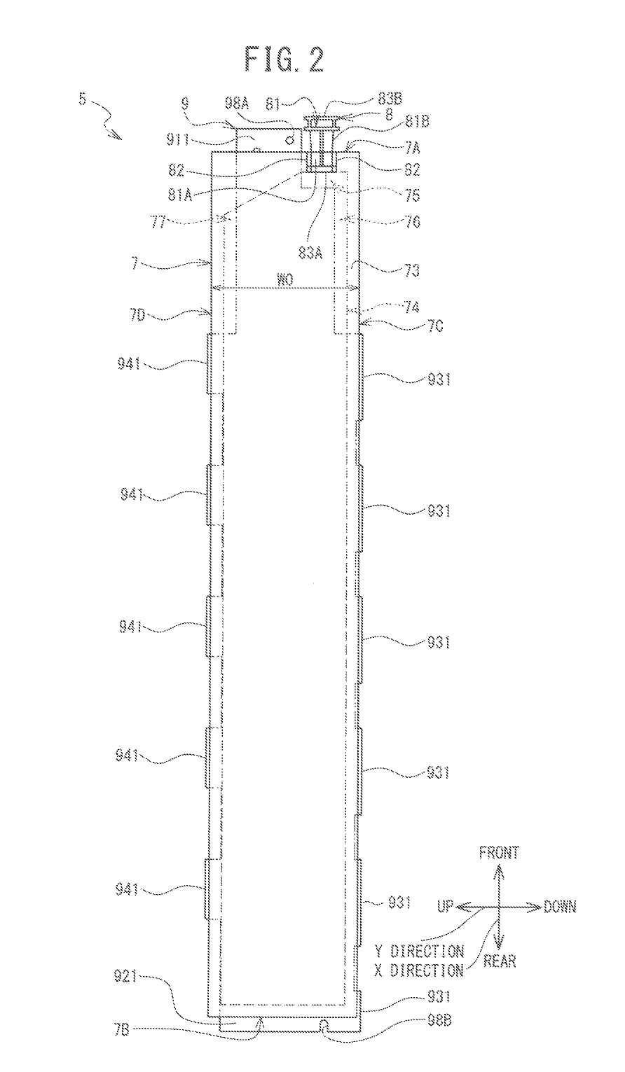

The cartridge mounting unit 110 is a portion on which the cartridge 1 is mounted, and, in the present embodiment, eight of the cartridges 1 can be mounted. The cartridge 1 is configured to house a liquid container 5 (refer to FIG. 2) configured to store a liquid. The eight cartridges 1 include four of the white ink cartridges 1, and four of the color cartridges 1 of each of cyan, magenta, yellow, and black. The four colors of the ink cyan, magenta, yellow, and black are collectively referred to as color inks. So that the printed fabric can offer high washing fastness, the ink includes a binder resin. The white ink includes titanium oxide, as a pigment, for example. The titanium oxide is an organic pigment having a relatively high specific gravity and is prone to sedimentation. Thus, the white ink is a liquid that includes a component that is more prone to sedimentation than components included in the color inks.

A substantially rectangular opening 112 that is long in the left-right direction is provided in the upper portion of the front surface of a housing 111 of the cartridge mounting unit 110. The cartridge mounting unit 110 includes a holder unit (not shown in the drawings) that is provided deeper to the inside than the opening 112. A user mounts or removes the cartridge 1 into or from the holder unit through the opening 112. The cartridge 1 of the present embodiment is mounted into or removed from the holder unit through the opening 112 while in a posture such that the front side and the upper side of the cartridge 1 are respectively oriented toward the rear side and the upper side of the printer 100. The cartridge mounting unit 110 includes a connecting portion provided deeper to the inside than the holder unit. The connecting portion includes a lead-out needle (not shown in the drawings) for leading out the ink.

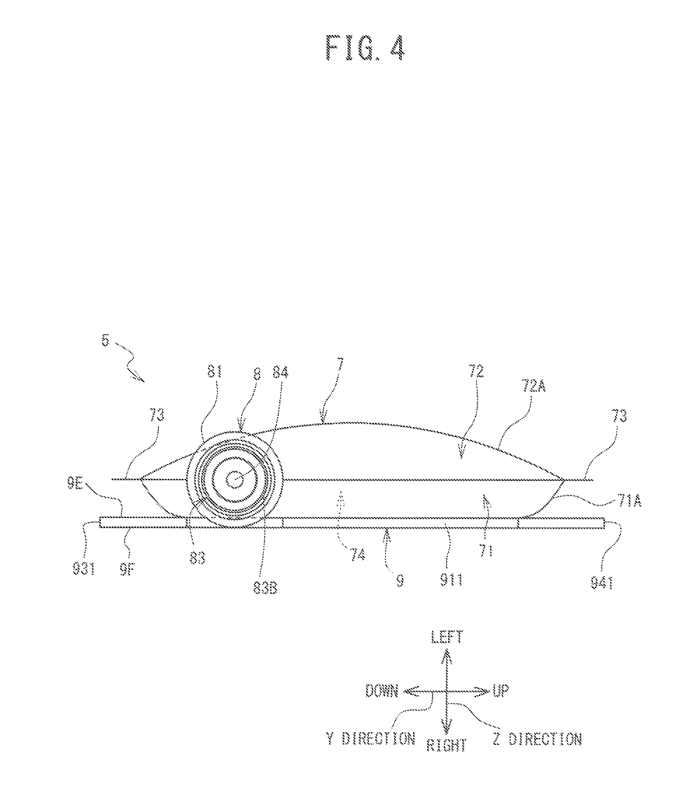

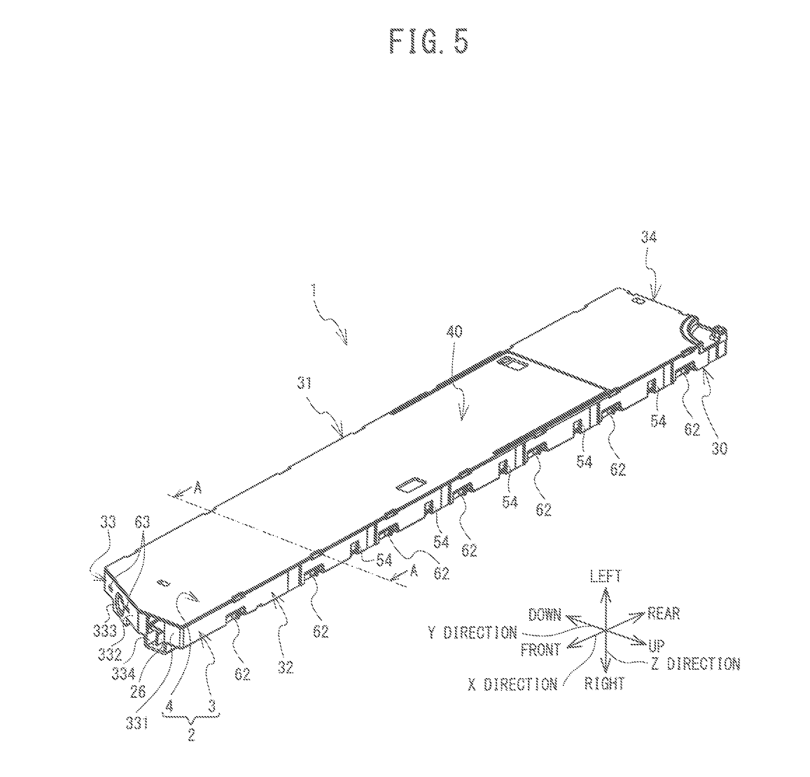

When the cartridge 1 is mounted in the holder unit, the lead-out needle enters into the interior of a main body 2 (refer to FIG. 5) from a plug opening 333 (refer to FIG. 5), and pierces a central portion of a rubber plug 84 (refer to FIG. 4). The leading end portion of the lead-out needle penetrates the rubber plug 84 in an X direction and is thus communicated with the interior of a reservoir portion 74 (refer to FIG. 4). One end of a tube (not shown in the drawings) is connected to the base end portion of the lead-out needle. The other end of the tube is connected to the print head (not shown in the drawings). Thus, ink inside the reservoir portion 74 is led out via the lead-out needle and is then supplied to the print head through the tube.

In the present embodiment, the eight cartridges 1 mounted in the cartridge mounting unit 110 supply ink to the eight print heads via the respective tubes (not shown in the drawings). Each of the print heads has a plurality of minute nozzles provided on a bottom surface of the print head. The nozzles eject ink droplets downward in accordance with the driving of a piezoelectric element. The printer 100 performs the printing on the fabric by ejecting the ink from the nozzles while moving the platen 102 on which the fabric is placed and the carriage.

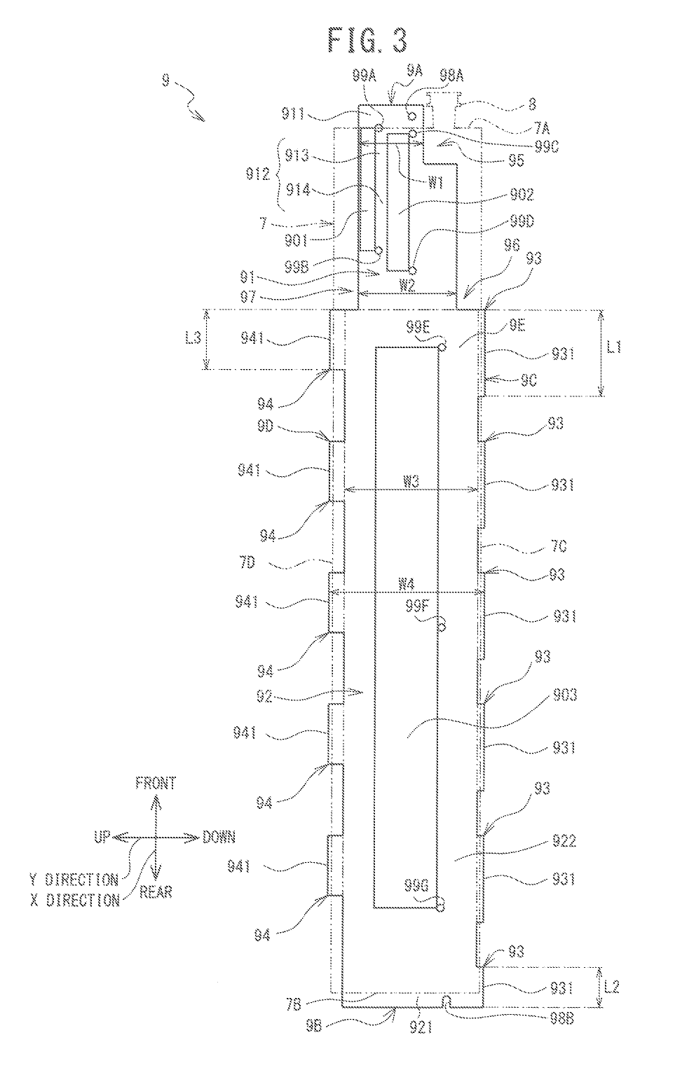

The configuration of the liquid container 5 will be explained with reference to FIG. 2 to FIG. 4. Hereinafter, an explanation will be made in which the upper side, the lower side, the left side, the right side, the front side on the page and the depth side on the page of FIG. 2 respectively define the front side, the rear side, the upper side, the lower side, the left side, and the right side of the liquid container 5. In FIG. 2, of a plate 9, a contour of a portion hidden by the right side of a storage portion 7 is shown using a two-dot chain line. In FIG. 3, contours of the storage portion 7 and a stopper 8 are respectively shown using two-dot chain lines.

As shown in FIG. 4, the liquid container 5 is provided with the storage portion 7, the stopper 8, and the plate 9. The storage portion 7 is a flexible member that is configured to internally store a liquid. The storage portion 7 is a bag-shaped container that is formed by two flexible rectangular-shaped resin sheets 71 and 72. The sheets 71 and 72 are overlapped with each other in a state in which respective one surfaces thereof face each other and peripheral edge portions thereof are thermally welded (heat sealed).

The storage portion 7 is thick in the left-right direction as a result of the right-side sheet 71 and the left-side sheet 72 being overlapped with each other and thermally welded. As shown in FIG. 2, the storage portion 7 extends in the front-rear direction and the up-down direction, which are orthogonal to the left-right direction. The longitudinal direction of the storage portion 7 is the front-rear direction, and the lateral direction of the storage portion 7 is the up-down direction. Hereinafter, the front-rear direction that is the longitudinal direction of the storage portion 7 is referred to as the X direction. The up-down direction that is the lateral direction of the storage portion 7 is referred to as a Y direction. The left-right direction that is the thickness direction of the storage portion 7 is referred to as a Z direction. A surface 71A of the sheet 71 and a surface 72A of the sheet 72 shown in FIG. 4 are both surfaces that extend in the X direction and the Y direction.

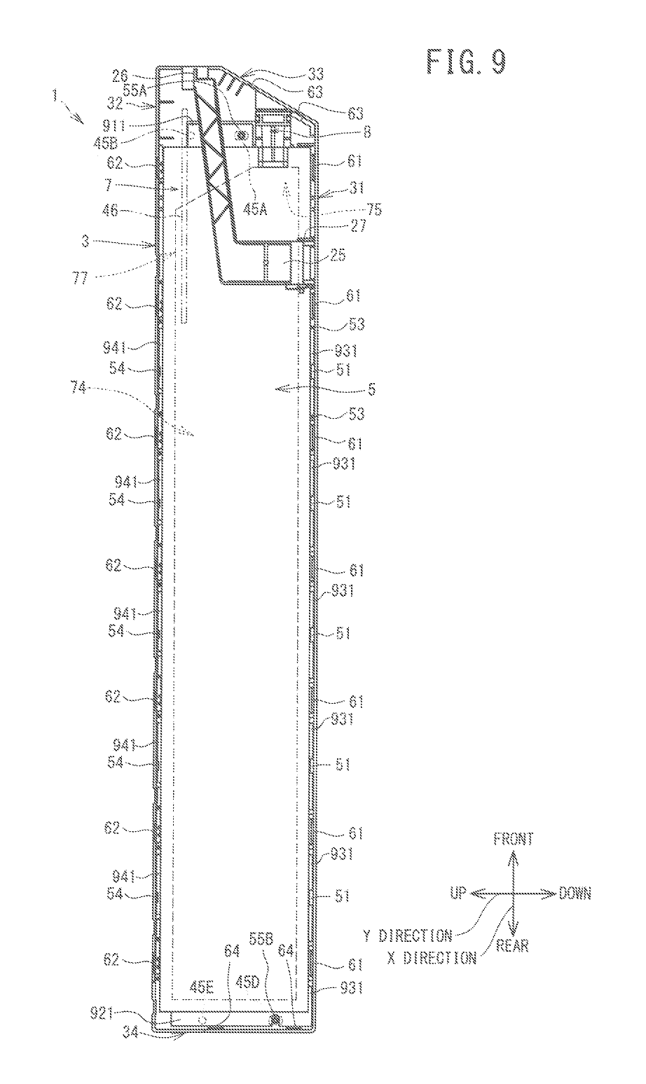

The storage portion 7 includes a peripheral portion 73, the reservoir portion 74, and a stopper communication portion 75. The peripheral portion 73 is a portion at which the sheets 71 and 72 are welded together. The reservoir portion 74 is a portion surrounded by the peripheral portion 73 and is a space that is formed between the sheets 71 and 72. In FIG. 2 and FIG. 9 (to be described later), the reservoir portion 74 is indicated using broken lines. In FIG. 3, broken lines indicating the reservoir portion 74 are omitted. The reservoir portion 74 is a portion of the liquid container 5 in which liquid is stored, and in the present embodiment, the white ink is stored as the liquid. As shown in FIG. 4, when a remaining amount of the white ink stored in the liquid container 5 is large, in the reservoir portion 74, the sheet 72 bends in a direction to separate from the sheet 71. When the remaining amount of the white ink stored in the liquid container 5 is small, in the reservoir portion 74, the sheet 72 deflects in a direction to come closer to the sheet 71. The length in the Z direction of the reservoir portion 74 changes in accordance with the remaining amount of the ink inside the reservoir portion 74.

As shown in FIG. 2, the two end portions of the storage portion 7 in the X direction are a front end portion 7A and a rear end portion 7B. The two end portions of the storage portion 7 in the Y direction are a lower end portion 7C and an upper end portion 7D. The stopper 8 is provided in the front end portion 7A, of the two end portions of the storage portion 7 in the X direction. Of the front end portion 7A, the stopper 8 is provided in a position closer to the lower end portion 7C than the upper end portion 7D. In other words, the stopper 8 is positioned further to the lower end portion 7C side than a central portion of the storage portion 7 in the Y direction. Of the reservoir portion 74, the stopper communication portion 75 is a portion that is communicated with the stopper 8 provided in the front end portion 7A. Since the stopper communication portion 75 causes the white ink to pass toward the stopper 8, the sheets 71 and 72 bend so as to bulge outward.

The stopper 8 is provided with a substantially cylindrically-shaped main body 81, and two vane-shaped connection portions 82. The two connection portions 82 protrude in mutually opposite directions from the outer peripheral surface of a rear end portion 81A of the main body 81. The two connection portions 82 and the rear end portion 81A are integrally welded with the peripheral portion 73, in a state of being inserted between the sheets 71 and 72. Thus, the stopper 8 is fixed to the storage portion 7. A portion of the main body 81 that is not welded with the peripheral portion 73 is a non-welded portion 81B. The non-welded portion 81B protrudes to the front of the storage portion 7 from the front end portion 7A.

The stopper 8 includes a cylindrically-shaped hollow portion 83 (refer to FIG. 4) that penetrates the interior of the main body 81 in the X direction. A first opening 83A (refer to FIG. 2) is provided in the rear end portion of the hollow portion 83 and is communicated with the reservoir portion 74 via the stopper communication portion 75. A second opening 83B is provided in the front end portion of the hollow portion 83 and is open to the outside of the storage portion 7. The column-shaped rubber plug 84 is inserted into the end portion of the hollow portion 83 on the second opening 83B side. The rubber plug 84 blocks the second opening 83B of the stopper 8, and thus, the reservoir portion 74 stores the white ink in a tightly sealed state. When the cartridge 1 is mounted in the holder unit (not shown in the drawings), the leading end portion of the above-described lead-out needle (not shown in the drawings) is disposed between the first opening 83A and the rubber plug 84, in the interior of the hollow portion 83. The white ink inside the reservoir portion 74 passes through the stopper communication portion 75, and is led out from the lead-out needle disposed inside the hollow portion 83.

As shown in FIG. 2 and FIG. 3, the plate 9 is a plate-shaped member that is fixed to the surface 71A (refer to FIG. 4) of the storage portion 7. The plate 9 has sufficient strength to be able to support the storage portion 7. For example, the rigidity of the plate 9 is greater than the rigidity of the sheets 71 and 72. The plate 9 can be formed as a paper board, as a resin plate, or as a metal plate, for example, and in the present embodiment, is produced by performing cut-out processing on cardboard. In the present embodiment, the longitudinal direction and the lateral direction of the plate 9 are respectively the X direction and the Y direction, similarly to the storage portion 7. As shown in FIG. 3, the two end portions of the plate 9 in the X direction are a front end portion 9A and a rear end portion 9B. The two end portions of the plate 9 in the Y direction are a lower end portion 9C and an upper end portion 9D. As shown in FIG. 4, of the two surfaces of the plate 9, the left surface fixed to the surface 71A is a fixing surface 9E. The right surface that is on the opposite side to the fixing surface 9E is an attachment surface 9F.

As shown in FIG. 3, the plate 9 includes a first plate portion 91, a second plate portion 92, a plurality of third plate portions 93, and a plurality of fourth plate portions 94. The first plate portion 91 is provided on the front end portion 9A of the plate 9, and includes a first protrusion portion 911 and a support plate portion 912. Of the first plate portion 91, the first protrusion portion 911 is a portion that protrudes toward the front away from the storage portion 7. The first protrusion portion 911 protrudes further to the front of the storage portion 7 than the front end portion 7A.

The first protrusion portion 911 is a rectangular shape that is long in the Y direction. The length of the first protrusion portion 911 in the X direction is smaller than the length of the non-welded portion 81B (refer to FIG. 2) of the stopper 8, and is, for example, approximately two thirds of the length of the non-welded portion 81B in the X direction. A width W1 that is the length of the first protrusion portion 911 in the Y direction is smaller than a width W0 (refer to FIG. 2) that is the length of the storage portion 7 in the Y direction, and is, for example, approximately one half of the width W0. The first protrusion portion 911 is in a position above and separated from the stopper 8, and is lower than the upper end portion 7D of the storage portion 7. Specifically, the first protrusion portion 911 protrudes further to the front of the storage portion 7 than the front end portion 7A, in a position between the stopper 8 and the upper end portion 7D in the Y direction.

Of the first plate portion 91, the support plate portion 912 is a portion that is to the rear side of the first protrusion portion 911. The support plate portion 912 is configured to support the front-end side portion of the storage portion 7. The length of the support plate portion 912 in the X direction is approximately one fifth of the length of the storage portion 7 in the X direction, for example. As will be described in more detail later, the length of the support plate portion 912 in the Y direction is smaller than the above-described width W0 (refer to FIG. 2). The support plate portion 912 is between the lower end portion 7C and the upper end portion 7D of the storage portion 7 in the Y direction.

The support plate portion 912 includes a first support portion 913 and a second support portion 914. The first support portion 913 is a portion that extends to the rear from the first protrusion portion 911 and is a rectangular shape that is long in the Y direction. The first protrusion portion 911 and the first support portion 913 form a rectangular shaped plate portion that is continuous in the X direction. Thus, the length of the first support portion 913 in the Y direction is substantially the same as the above-described width W1. The length of the first support portion 913 in the X direction is greater than the length of the stopper communication portion 75 (refer to FIG. 2) in the X direction.

The second support portion 914 is a portion that extends to the rear from the first support portion 913 and is a rectangular shape that is long in the X direction. The upper edges of each of the first protrusion portion 911, the first support portion 913, and the second support portion 914 are continuous in the X direction and form the upper edge of the first plate portion 91. The second support portion 914 extends further downward than the first support portion 913. A width W2 that is the length of the second support portion 914 in the Y direction is smaller than the above-described width W0 and greater than the above-described width W1, and is, for example, approximately two thirds of the width W0. A central portion of the second support portion 914 in the Y direction is substantially aligned with a central portion of the storage portion 7 in the Y direction.

The first plate portion 91 having the above-described configuration is, overall, a rectangular shape whose lower front corner portion is cut out in a right-angled shape. A cut-out portion 95 is the space formed by cutting out the lower front corner portion of the first plate portion 91. The stopper communication portion 75 (refer to FIG. 2) is disposed to the left of the cut-out portion 95. Thus, the cut-out portion 95 exposes the stopper communication portion 75 to the right. The first support portion 913 is provided in a position separated upward from the stopper communication portion 75. The second support portion 914 is provided in a position separated rearward from the stopper communication portion 75. In other words, the first plate portion 91 is in a position separated from the stopper 8 and the stopper communication portion 75 in the X direction and the Y direction.

The second plate portion 92 is a portion that extends from the first plate portion 91 to the rear end portion 9B of the plate 9 and is a rectangular shape that is long in the X direction. A width W3 that is the length of the second plate portion 92 in the Y direction is smaller than the above-described width W0 (refer to FIG. 2) and greater than the above-described width W2, and is, for example, approximately nine tenths of the width W0. The second plate portion 92 is between the lower end portion 7C and the upper end portion 7D of the storage portion 7 in the Y direction. The central portion of the second plate portion 92 in the Y direction is slightly below the central portion of the storage portion 7 in the Y direction.

The second plate portion 92 includes a second protrusion portion 921 and a support plate portion 922. Of the second plate portion 92, the second protrusion portion 921 is a portion that protrudes toward the rear away from the storage portion 7. The second protrusion portion 921 protrudes further to the rear of the storage portion 7 than the rear end portion 7B. The second protrusion portion 921 is a rectangular shape that is long in the Y direction. Of the second plate portion 92, the support plate portion 922 is a portion that is to the front of the second protrusion portion 921. The support plate portion 922 is configured to support the whole of the storage portion 7 in the X direction, excepting the front-end side portion. The length of the support plate portion 922 in the X direction is, for example, approximately four fifths of the length of the storage portion 7 in the X direction.

As described above, the width W3 is greater than the widths W1 and W2. Thus, a cut-out portion 96 is formed in the lower side of the first plate portion 91 and the front side of the second plate portion 92. A cut-out portion 97 is formed in the upper side of the first plate portion 91 and the front side of the second plate portion 92.

The cut-out portion 96 is a space formed by cutting out the lower front corner portion of the plate 9, and extends to the rear from the lower side of the above-described cut-out portion 95. Specifically, the cut-out portion 95 is positioned below the first support portion 913, and the cut-out portion 96 is positioned below the second support portion 914. The cut-out portion 97 is a space formed by cutting out the upper front corner portion of the plate 9 and extends to the rear from the upper side of the above-described first support portion 913.

A relief portion 76 (refer to FIG. 2) of the storage portion 7 is disposed to the left of the cut-out portion 96. Of the reservoir portion 74 (refer to FIG. 2), the relief portion 76 is a portion that extends, at the lower end portion 7C, from the stopper communication portion 75 (refer to FIG. 2) toward the rear end portion 7B. An unsupported portion 77 (refer to FIG. 2) of the storage portion 7 is disposed to the left of the cut-out portion 97. The plate 9 does not support the unsupported portion 77. Thus, the unsupported portion 77 is a portion exposed to the right at the upper front corner portion of the storage portion 7.

The plurality of third plate portions 93 are provided on the lower end portion 9C of the plate 9. In the present embodiment, six of the third plate portions 93 are disposed side by side in the X direction at equal intervals and protrude downward from the lower edge of the second plate portion 92. Each of the third plate portions 93 is a rectangular shape that is long in the X direction and each includes a first convex portion 931. Of the third plate portion 93, the first convex portion 931 is a portion that protrudes downward away from the storage portion 7. The first convex portion 931 protrudes below the storage portion 7 further than the lower end portion 7C.

The third plate portion 93 furthermost to the front protrudes downward from the lower front corner portion of the second plate portion 92. The third plate portion 93 furthermost to the rear protrudes downward from the lower rear corner portion of the second plate portion 92. The lengths of the six third plate portions 93 in the Y direction are substantially the same. Except for the third plate portion 93 furthermost to the rear, a length L1 of each of the five third plate portions 93 in the X direction is substantially the same. A length L2 in the X direction of the third plate portion 93 furthermost to the rear is smaller than the length L1.

The plurality of fourth plate portions 94 are provided on the upper end portion 9D of the plate 9. In the present embodiment, five of the fourth plate portions 94 are disposed side by side in the X direction at equal intervals and protrude upward from the upper edge of the second plate portion 92. Each of the fourth plate portions 94 is a rectangular shape that is long in the X direction and each includes a second convex portion 941. Of the fourth plate portion 94, the second convex portion 941 is a portion that protrudes upward away from the storage portion 7. The second convex portion 941 protrudes above the storage portion 7 further than the upper end portion 7D.

The fourth plate portion 94 furthermost to the front protrudes upward from the upper front corner portion of the second plate portion 92. The lengths of the five fourth plate portions 94 in the Y direction are substantially the same. A length L3 of each of the five fourth plate portions 94 in the X direction is substantially the same. The length L3 is smaller than the above-described length L1 and is greater than the above-described length L2. The length of each of the second convex portions 941 in the Y direction is substantially the same as the length of each of the first convex portions 931 in the Y direction.

In the present embodiment, the front end position of each of the five third plate portions 93 having the length L1 and the front end position of each of the five fourth plate portions 94 are in the same position as each other in the X direction. For the third plate portions 93 and the fourth plate portions 94 facing each other in the Y direction, the rear end position of each of the third plate portions 93 is further to the rear than the rear end position of each of the fourth plate portions 94. In other words, the rear end position of each of the third plate portions 93 and the rear end position of each of the fourth plate portions 94 are mutually different positions in the X direction. Thus, the six first convex portions 931 and the five second convex portions 941 are in mutually different positions in the X direction. Note that the length of the plate 9 in the Y direction is at a maximum at the X direction positions where the first convex portions 931 and the second convex portions 941 face each other in the Y direction. The maximum length of the plate 9 in the Y direction is referred to as a width W4. Specifically, the width W4 is a length from the lower end of the first convex portion 931 to the upper end of the second convex portion 941.

The first protrusion portion 911 has a first hole 98A, which is a hole penetrating the first protrusion portion 911 in the Z direction. Specifically, the first hole 98A is aligned with the stopper 8 in the Y direction, at a predetermined position in the X direction. In the Y direction, the first hole 98A is provided between the central portion of the first protrusion portion 911 in the Y direction and the stopper 8. Specifically, the first hole 98A is further to the cut-out portion 95 side than the central portion of the first protrusion portion 911 in the Y direction. The second protrusion portion 921 has a second hole 98B, which is a hole penetrating the second protrusion portion 921 in the Z direction. In the Y direction, the second hole 98B is provided in a substantially central position between the central portion of the second protrusion portion 921 in the Y direction and the lower end portion of the second protrusion portion 921. The second hole 98B is formed by a part of the second protrusion portion 921 being cut out from the rear.

The plate 9 has a plurality of indicator holes 99A to 99G, which are holes penetrating the plate 9 in the Z direction. The indicator holes 99A to 99G indicate areas in which a plurality of bonding members 901 to 903 are to be disposed. The plurality of bonding members 901 to 903 are disposed on the fixing surface 9E (refer to FIG. 4). In an area in which the fixing surface 9E and the surface 71A (refer to FIG. 4) overlap with each other, the plurality of bonding members 901 to 903 bond the plate 9 to the storage portion 7. Each of the bonding members 901 to 903 of the present embodiment is a rectangular-shaped double-sided adhesive tape that is long in the X direction.

The indicator holes 99A and 99B are provided in the first plate portion 91 and indicate the area in which the bonding member 901 is to be disposed. The indicator hole 99A is provided on a boundary line between the first protrusion portion 911 and the first support portion 913. The indicator hole 99A is slightly above the central portion of the first protrusion portion 911 in the Y direction. The indicator hole 99B is provided in the second support portion 914. The indicator hole 99B is positioned in the same position as the indicator hole 99A in the X direction and is separated to the rear from the indicator hole 99A. The position of the bonding member 901 is determined by the lower front corner portion and the lower rear corner portion of the bonding member 901 being respectively positioned on the upper end portions of each of the indicator holes 99A and 99B. At this time, the bonding member 901 is correctly disposed along the upper edge of the first plate portion 91 and the above-described boundary line.

The indicator holes 99C and 99D are provided in the first plate portion 91 and indicate the area in which the bonding member 902 is to be disposed. The indicator hole 99C is provided in the lower front portion of the first support portion 913. The indicator hole 99D is provided in the second support portion 914. The indicator hole 99D is positioned in the same position as the indicator hole 99C in the Y direction and is separated to the rear from the indicator hole 99C. The position of the bonding member 902 is determined by the lower front corner portion and the lower rear corner portion of the bonding member 902 being respectively positioned on the upper end portions of each of the indicator holes 99C and 99D. At this time, the bonding member 902 is correctly disposed without overlapping with the bonding member 901.

The indicator holes 99E to 99G are provided in the support plate portion 922 of the second plate portion 92 and indicate the area in which the bonding member 903 is to be disposed. The indicator hole 99E is provided in the lower front portion of the support plate portion 922. The indicator hole 99G is provided in the lower rear portion of the support plate portion 922. The indicator hole 99F is provided in an intermediate position between the indicator hole 99E and the indicator hole 99G. Specifically, the indicator holes 99E to 99G are aligned in the X direction so as to be in the same position as each other in the Y direction. The position of the bonding member 903 is determined by the lower front corner portion, the central portion of the lower edge, and the lower rear corner portion of the bonding member 903 being respectively positioned on the upper end portions of each of the indicator holes 99E to 99G. At this time, the bonding member 903 is correctly disposed in an inside area of the support plate portion 922. The position of the bonding member 903 in the Y direction is substantially aligned with the position of the storage portion 7 in the Y direction.

The liquid container 5 having the above-described configuration is manufactured in the following manner. As shown in FIG. 3, first an operator disposes the bonding members 901 to 903 on the fixing surface 9E (refer to FIG. 4) of the plate 9. At that time, as described above, the operator determines the position of the bonding member 901 on the upper side of the indicator holes 99A and 99B. The operator determines the position of the bonding member 902 on the upper side of the indicator holes 99C and 99D. The operator determines the position of the bonding member 903 on the upper side of the indicator holes 99E to 99G.

As shown in FIG. 2, the operator next disposes the storage portion 7, in which the white ink is stored in the reservoir portion 74, on the fixing surface 9E. At that time, the operator determines the position of the storage portion 7 in the X direction such that it is between the first hole 98A and the second hole 98B, so that the first hole 98A and the second hole 98B are not covered by the storage portion 7. Thus, in the X direction, the storage portion 7 is between the first hole 98A and the second hole 98B. Further, the operator determines the position of the storage portion 7 in the Y direction such that the central portion of the width W0 of the storage portion 7 is substantially aligned with the central portion of the width W4 (refer to FIG. 3) of the plate 9. In addition, the operator determines the position of the stopper 8 such that it is aligned with the first hole 98A in the Y direction and bonds the stopper 8. At that time, the operator determines the position of the stopper 8 to be closely below the first hole 98A, of both sides in the Y direction of the first protrusion portion 911. The liquid container 5 shown in FIG. 2 is completed in this way. Note that the operator can fix the storage portion 7 more accurately with respect to the plate 9 by using a specific jig at the time of the above-described operations.

The configuration of the cartridge 1 will be explained with reference to FIG. 5 to FIG. 8. Hereinafter, the upper side, the lower side, the lower left side, the upper right side, the upper left side, and the lower right side in FIG. 5 respectively define the left side, the right side, the front side, the rear side, the lower side, and the upper side of the cartridge 1. As shown in FIG. 5, the main body 2 of the cartridge 1 is a cuboid shape. The longitudinal direction of the main body 2 is the front-rear direction, and the lateral direction of the main body 2 is the up-down direction. The main body 2 is provided with a case 3 and a lid 4 that will be described later.

In the present embodiment, the operator houses the liquid container 5 inside the main body 2 such that the front-rear direction, the left-right direction, and the up-down direction of the liquid container 5 are respectively aligned with the front-rear direction, the left-right direction, and the up-down direction of the cartridge 1. Thus, the front-rear direction that is the longitudinal direction of the main body 2 corresponds to the above-described X direction. The up-down direction that is the lateral direction of the main body 2 corresponds to the above-described Y direction, The left-right direction that is the thickness direction of the main body 2 corresponds to the above-described Z direction.

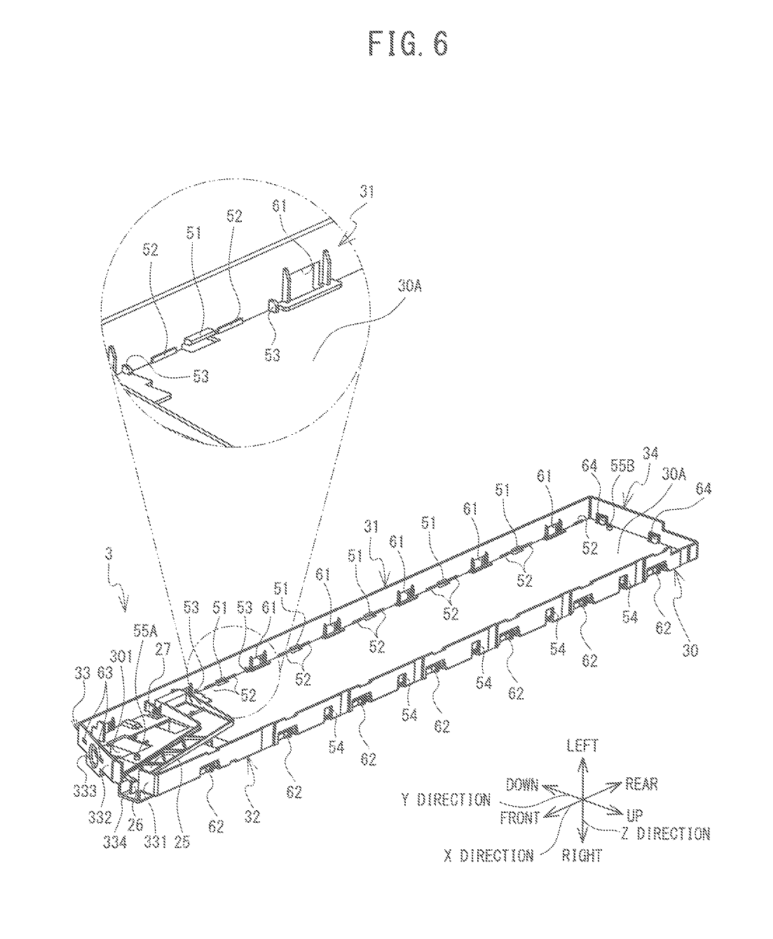

As shown in FIG. 5 and FIG. 6, the case 3 includes a right wall 30, a bottom wall 31, a top wall 32, a front wall 33, and a rear wall 34. The right wall 30 is a substantially pentagonally-shaped wall that extends in the X direction and the Y direction. The bottom wall 31, the top wall 32, the front wall 33, and the rear wall 34 extend leftward to substantially the same length from the right wall 30, along the outer periphery of the right wall 30. The right wall 30, the bottom wall 31, the top wall 32, the front wall 33, and the rear wall 34 respectively form the right surface, the left surface, the top surface, the front surface and the rear surface of the main body 2. The front wall 33 includes a front surface portion 331 and an inclined surface portion 332. The front surface portion 331 is connected to the top wall 32 at a right angle. The inclined surface portion 332 diagonally joins the bottom wall 31 to the front surface portion 331.

As shown in FIG. 5, the lid 4 is mainly configured by a left wall 40. The left wall 40 is a wall portion that extends in the X direction and the Y direction and is a substantially pentagonal shape that corresponds to the right wall 30 of the case 30. The left wall 40 faces the right wall 30 and forms the left surface of the main body 2.

As shown in FIG. 6, the front surface portion 331 has an exposure opening 334, which is a rectangular shape that is long in the Z direction. The exposure opening 334 is an opening for exposing an exposed portion 26 (to be described later) to the front side of the main body 2. The inclined surface portion 332 has a circular stopper opening 333. The stopper opening 333 is an opening for leading out the white ink from the storage portion 7 (refer to FIG. 4) of the liquid container 5 housed inside the main body 2. The liquid container 5 is disposed inside the main body 2 such that the second opening 83B (refer to FIG. 4) of the stopper 8 faces the stopper opening 333. The right wall 30 includes a stopper placement portion 301 provided in a position facing the stopper opening 333. The stopper placement portion 301 is a portion that is recessed to the right side. The stopper placement portion 301 determines and fixes the position of the stopper with respect to the case 3.

A remaining amount detection plate 25 for detecting a remaining amount of the liquid stored in the liquid container 5 (refer to FIG. 4) is provided on the case 3. The remaining amount detection plate 25 is a substantially L-shaped plate member. A shaft portion 27 is provided in the vicinity of the left end portion on the top surface of the bottom wall 31. One end of the remaining amount detection plate 25 is coupled to the shaft portion 27. The shaft portion 27 is further to the rear than the stopper placement portion 301, in the front-end side portion of the bottom wall 31. The remaining amount detection plate 25 extends upward from the shaft portion 27 to the central portion of the case 3 in the Y direction, and then extends to the front and upward toward the exposure opening 334. The rectangular exposed portion 26 is provided at the other end of the remaining amount detection plate 25. The exposed portion 26 is exposed to the front side of the main body 2 via the exposure opening 334. The shaft portion 27 supports the remaining amount detection plate 25 such that the remaining amount detection plate 25 can rotate in the Z direction, and urges the remaining amount detection plate 25 to the right due to the elastic force of a torsion spring (not shown in the drawings).

Of the left surface of the right wall 30, a flat surface on which the plate 9 (refer to FIG. 4) is disposed is a placement surface 30A. On the placement surface 30A, a distance between the bottom wall 31 and the top wall 32 in the Y direction is slightly greater than the above-described width W4 (refer to FIG. 3) of the plate 9. A plurality of lower tab portions 51, a plurality of ribs 52, a pair of ribs 53, a plurality of upper tab portions 54, and pins 55A and 55B are provided on the case 3 in order to fix the plate 9 (refer to FIG. 4) in an accurate position.

The plurality of lower tabs 51 are provided side by side in the X direction so as to correspond to the plurality of first convex portions 931 (refer to FIG. 2). Each of the lower tab portions 51 is disposed in a position corresponding to the central portion in the X direction of the corresponding first convex portion 931. In the present embodiment, five of the lower tab portions 51 are provided corresponding to the five first convex portions 931 having the length L1. Each of the lower tab portions 51 protrudes upward from the bottom wall 31 and is a plate-shaped protrusion that is long in the X direction. Each of the lower tab portions 51 is in a position separated slightly to the left from the placement surface 30A.

The length of each of the lower tab portions 51 in the X direction is equal to or less than the length of the first convex portion 931 in the X direction, and is, for example, approximately one sixth of the above-described length L1 (refer to FIG. 3). The length of each of the lower tab portions 51 in the Y direction is equal to or less than the length of the first convex portion 931 in the Y direction, and is, for example, approximately one half of the length of the first convex portion 931 in the Y direction. A distance between each of the lower tab portions 51 and the placement surface 30A in the Z direction is substantially the same as the length of the first convex portion 931 in the Z direction.

The plurality of ribs 52 are provided side by side in the X direction so as to correspond to the plurality of first convex portions 931. In the present embodiment, two of the ribs 52 are respectively provided corresponding to each of the five first convex portions 931 having the length L1. One of the ribs 52 is provided corresponding to the one first convex portion 931 having the length L2. In other words, a total of eleven of the ribs 52 are provided. The two ribs 52 respectively corresponding to each of the first convex portions 931 having the length L1 are disposed to the front and the rear of each of the lower tab portions 51, namely, to both sides of each of the lower tab portions 51 in the X direction. The one rib 52 corresponding to the first convex portion 931 having the length L2 is disposed in a position corresponding to the central portion, in the X direction, of the lower tab portion 51 positioned furthermost to the rear.

Each of the ribs 52 protrudes upward from the bottom wall 31 along the placement surface 30A and is a protruding shape that is long in the X direction. The length of each of the ribs 52 in the X direction is approximately the same as the length of the lower tab portion 51 in the X direction, for example. The length of each of the ribs 52 in the Z direction is substantially the same as the length of the first convex portion 931 in the Z direction. A distance between each of the ribs 52 and the top wall 32 in the Y direction is substantially the same as the width W4 (refer to FIG. 3).

The pair of ribs 53 are provided side by side in the X direction so as to correspond to both end portions of the first convex portion 931 that is furthermost to the front, of the plurality of first convex portions 931 (refer to FIG. 2). Specifically, the pair of ribs 53 are provided corresponding to the first convex portion 931 closest to the stopper 8 (refer to FIG. 4). Each of the ribs 53 is provided on respective corner portions connecting the placement surface 30A and the bottom wall 31. Each of the ribs 53 is a plate-shaped protrusion that extends in the Y direction and the Z direction along the placement surface 30A and the bottom wall 31.

The length of each of the ribs 53 in the Y direction is equal to or less than the length of the first convex portion 931 in the Y direction, and is, for example, approximately the same as the length of the lower tab portion 51 in the Y direction. The length of each of the ribs 53 in the Z direction is equal to or less than the length of the first convex portion 931 in the Z direction. The rib 53 on the front side is positioned slightly to the rear of the remaining amount detection plate 25. A distance between the front side rib 53 and the rear side rib 53 in the X direction is substantially the same as the length L1 (refer to FIG. 3). The lower tab portion 51 and the two ribs 52 corresponding to the first convex portion 931 that is furthermost to the front are between the pair of ribs 53 in the X direction.

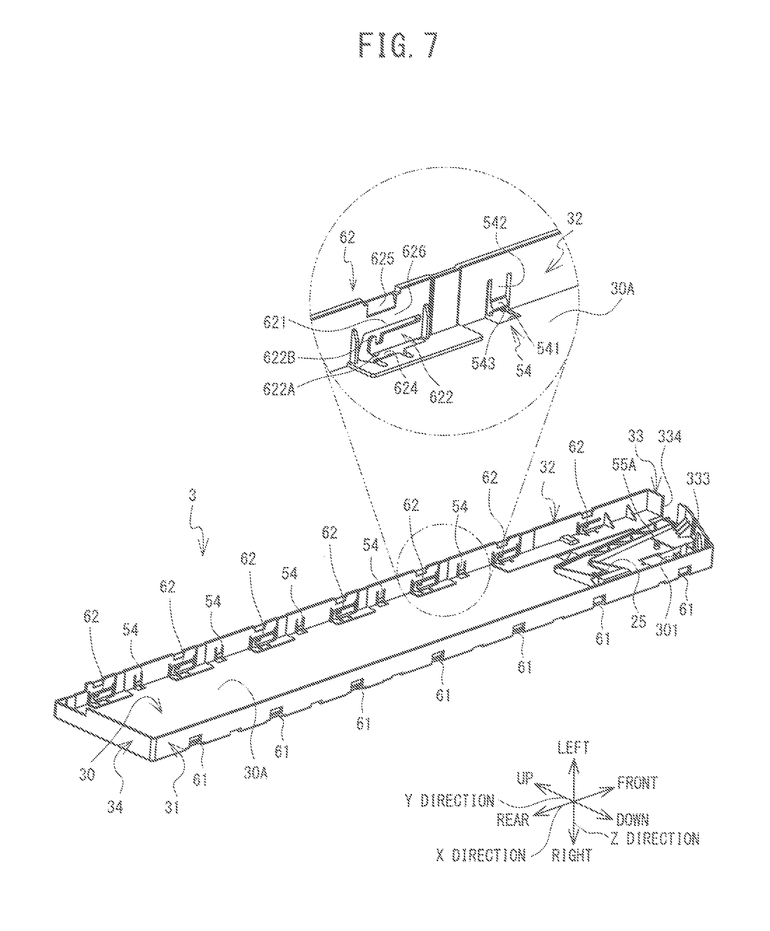

As shown in FIG. 7, the plurality of upper tab portions 54 are provided side by side in the X direction so as to correspond to the plurality of second convex portions 941 (refer to FIG. 4). Each of the upper tab portions 54 is disposed in a position slightly to the rear of the central portion, in the X direction, of the corresponding second convex portion 941. In the present embodiment, five of the upper tab portions 54 are provided corresponding to the five second convex portions 941. Each of the upper tab portions 54 includes an opening 541, an arm portion 542, and a protrusion 543. The opening 541 is a portion that is cut out from a corner portion connecting the right wall 30 and the top wall 32. The arm portion 542 is a plate-shaped portion that extends to the right from the left edge portion of the opening 541, on the inside of the opening 541. The arm portion 542 is configured to swing in the Y direction inside the opening 541, due to elastic deformation.

The protrusion 543 protrudes downward from the arm portion 542. The protrusion 543 is positioned so as to be slightly separated to the left from the placement surface 30A. The protrusion 543 has an inclined surface that extends downward and to the right from the bottom surface of the arm portion 542. The length of the protrusion 543 in the X direction is equal to or less than the length of the second convex portion 941 in the X direction, and is, for example, approximately one sixth of the above-described length L3 (refer to FIG. 3). The length of the protrusion 543 in the Y direction is equal to or less than the length of the second convex portion 941 in the Y direction, and is, for example, approximately one half of the length of the second convex portion 941 in the Y direction. A distance between the protrusion 543 and the placement surface 30A in the Z direction is substantially the same as the length of the second convex portion 941 in the Z direction.

As shown in FIG. 6, the pin 55A is provided on the front-end side portion of the placement surface 30A and is a cylindrical body that protrudes to the left from the right wall 30. The pin 55A is provided in a position corresponding to the first hole 98A (refer to FIG. 2) and has a diameter that is slightly smaller than the diameter of the first hole 98A. The pin 55B is provided on the rear-end side portion of the placement surface 30A and is a cylindrical body that protrudes to the left from the right wall 30. The pin 55B is provided in a position corresponding to the second hole 98B (refer to FIG. 2) and has a diameter that is slightly smaller than the diameter of the second hole 98B.

As shown in FIG. 6 and FIG. 7, a plurality of lower engaging portions 61, a plurality of upper engaging portions 62, a pair of front engaging portions 63, and a pair of rear engaging portions 64 are provided on the case 3 in order to fix the lid 4 (refer to FIG. 5) in an accurate position.

The plurality of lower engaging portions 61 are rectangular shaped openings that penetrate the bottom wall 31 and that are long in the X direction. In the present embodiment, seven of the lower engaging portions 61 are provided side by side in the X direction. The lower engaging portion 61 furthermost to the front is located on the front-end side portion of the bottom wall 31. The lower engaging portion 61 that is second from the front is located between the shaft portion 27 and the front side rib 53 in the X direction. The lower engaging portion 61 furthermost to the rear is located between the two ribs 52 in the X direction. The remaining four lower engaging portions 61 are respectively located in intermediate positions between the mutually adjacent lower tab portions 51 in the X direction.

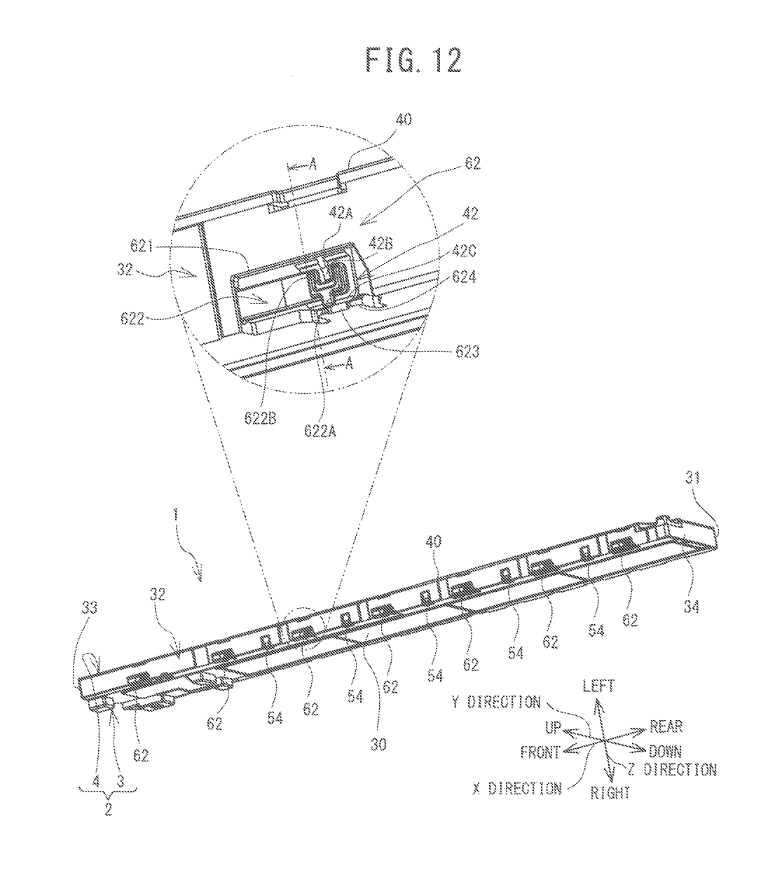

The plurality of upper engaging portions 62 are provided so as to correspond to the plurality of lower engaging portions 61 in the Y direction. In the present embodiment, seven of the upper engaging portions 62 are disposed side by side in the X direction, in positions facing the seven lower engaging portions 61 in the Y direction. The five upper engaging portions 62 on the rear side are respectively disposed to the rear of the upper tab portions 54. As shown in FIG. 7 and FIG. 12, each of the upper engaging portions 62 includes an opening 621, a receiving plate 622, a regulating portion 623 (refer to FIG. 12), an inclined surface 624, a guide surface 625, and a holding surface 626.

The opening 621 is a portion that is cut out from a corner portion connecting the right wall 30 and the top wall 32 and is a rectangular shape that is long in the X direction. The receiving plate 622 is a plate-shaped portion that extends to the rear from the front edge portion of the opening 621, on the inside of the opening 621. The length of the receiving plate 622 in the X direction is greater than the length of the opening 621 in the Z direction. The receiving plate 622 is configured swing in the Y direction, on the inside of the opening 621, due to elastic deformation. The receiving plate 622 includes a convex portion 622A and a concave portion 622B. The convex portion 622A is a portion, on the rear-end side portion of the receiving plate 622, that protrudes to the right. The concave portion 622B is a portion, on the rear-end side portion of the receiving plate 622, that is recessed from the left side to the right.

As shown in FIG. 12, the regulating portion 623 is a portion, of the upper end portion of the right wall 30 that forms the opening 621, that faces the convex portion 622A in the Y direction. As shown in FIG. 7, of the right wall 30, the inclined surface 624 is a surface that extends downward and to the left from the left end portion of the regulating portion 623. The inclined surface 624 is provided in a position facing the opening 621 in the Y direction, inside the case 3. The inclined surface 624 is inclined to the left from the right wall 30 toward the left wall 40 (refer to FIG. 5), while inclining downward from the opening 621 toward the inside of the case 3. The guide surface 625 is a surface that extends downward and to the right, at the left end portion of the top wall 32. The guide surface 625 is a rectangular shape that extends in the X direction on the left side of the concave portion 622B. The holding surface 626 is a portion of the bottom surface of the top wall 32 that is located between the guide surface 625 and the opening 621.

As shown in FIG. 6, the pair of front engaging portions 63 are provided on both sides, in the Y direction, of the stopper opening 33 in the inclined surface portion 332, and each is a rectangular shaped opening that extends in the Y direction. The pair of rear engaging portions 64 are provided side by side in the Y direction in the rear wall 34 and are square frame-shaped portions that protrude slightly to the front.

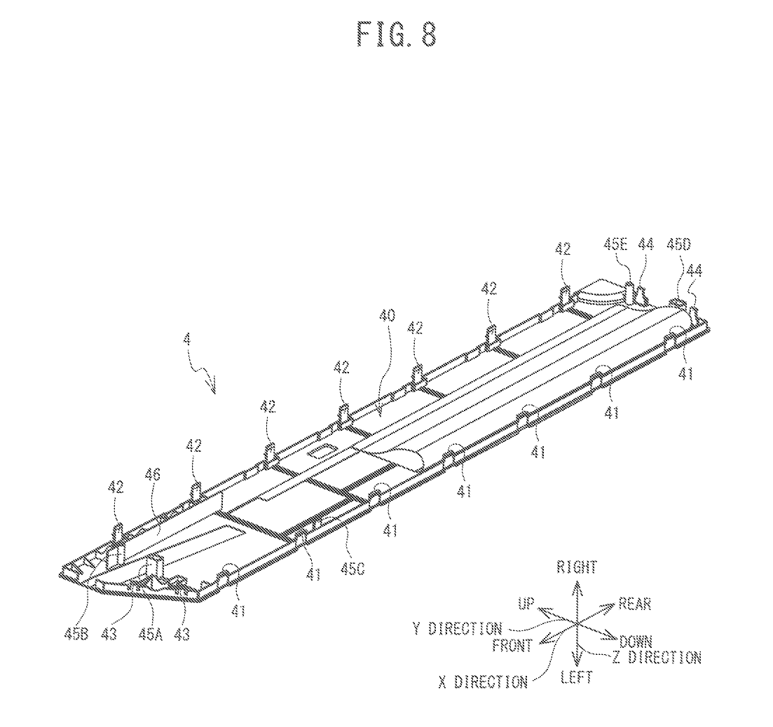

As shown in FIG. 8, a plurality of lower projecting pieces 41, a plurality of upper projecting pieces 42, a pair of front projecting pieces 43, and a pair of rear projecting pieces 44 are provided on the peripheral edge portion of the left wall 40 of the lid 4, as a plurality of projecting pieces that protrude to the right. The plurality of lower projecting pieces 41 are provided side by side in the X direction so as to correspond to the plurality of lower engaging portions 61 (refer to FIG. 6). Each of the lower projecting pieces 41 includes an engagement tab 41A configured to engage with the corresponding lower engaging portion 61. In the present embodiment, seven of the lower projecting pieces 41 are provided corresponding to the seven lower engaging portions 61.

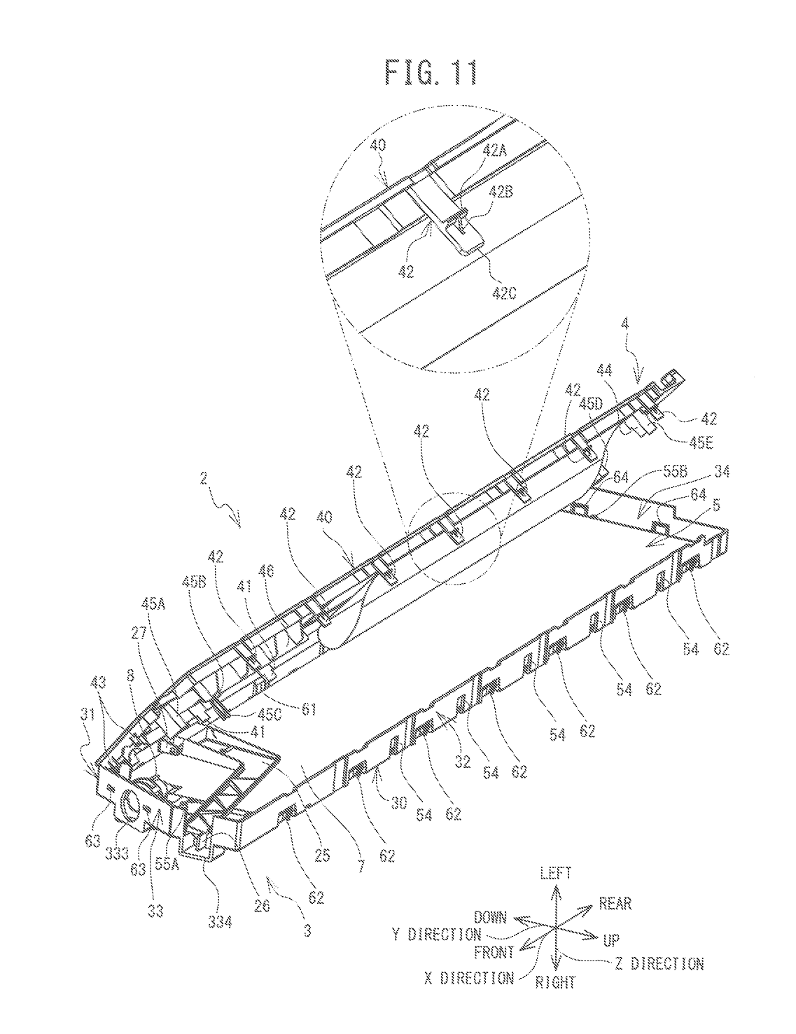

The plurality of upper projecting pieces 42 are provided side by side in the X direction so as to correspond to the plurality of upper engaging portions 62 (refer to FIG. 7). The length of each of the upper projecting pieces 42 in the Z direction is greater than the length, in the Z direction, of each of the lower projecting pieces 41, the front projecting pieces 43, and the rear projecting pieces 44. As shown in FIG. 11, the right end portion of each of the upper projecting pieces 42 is a projecting end portion 42C. Each of the upper projecting pieces 42 includes an engagement tab 42A, which protrudes upward slightly to the left of the projecting end portion 42C, and an inclined portion 42B. The engagement tab 42A is a plate-shaped protrusion that extends in the X direction and is configured to engage with the opening 621 (refer to FIG. 7). The inclined portion 42B extends to the right from the central portion of the engagement tab 42A in the X direction. The inclined portion 42B extends toward the right, from the central portion, in the X direction, of the engagement tab 42A. The inclined portion 42B bends downward so as to approach the upper surface of the upper projecting piece 42, along the right direction.

As shown in FIG. 8, the pair of front projecting pieces 43 are provided side by side in the Y direction so as to correspond to the pair of front engaging portions 63 (refer to FIG. 6). Each of the front projecting pieces 43 includes an engagement tab configured to engage with the corresponding front engaging portion 63. The pair of rear projecting pieces 44 are provided side by side in the Y direction so as to correspond to the pair of rear engaging portions 64 (refer to FIG. 6). Each of the rear projecting pieces 44 includes an engagement tab configured to engage with the corresponding rear engaging portion 64.

A plurality of pressing portions 45A to 45E, which protrude to the right, and a support portion 46 are provided on the right surface of the left wall 40. The length of each of the pressing portions 45A to 45E in the Z direction is approximately the same as the length of the upper projecting piece 42 in the Z direction. The pressing portion 45A is provided in a position corresponding to the pin 55A (refer to FIG. 6), in the front-end side portion of the left wall 40. The pressing portion 45A is a tubular-shaped portion having an elliptical opening that is long in the Y direction, and has an inner diameter that is equal to or greater than the diameter of the pin 55A. The pressing portion 45B is a cylindrically-shaped body with a small diameter that is provided above the pressing portion 45A. The pressing portion 45B is provided in a position corresponding to a position slightly above the remaining amount detection plate 25 (refer to FIG. 6).

The pressing portion 45C is a plate-shaped protrusion provided in the vicinity of the lower end portion of the left wall 40. The pressing portion 45C is provided, in the X direction, in a position corresponding to an area between the front side rib 53 (refer to FIG. 6) and the lower tab portion 51 that is furthermost to the front (refer to FIG. 6). The pressing portion 45D is provided in a position corresponding to the pin 55B (refer to FIG. 6), in the rear-end side portion of the left wall 40. The pressing portion 45D is a is a tubular-shaped portion having an elliptical opening that is long in the Y direction, and has an inner diameter that is equal to or greater than the diameter of the pin 55B. The pressing portion 45E is a cylindrically-shaped body with a small diameter that is provided above the pressing portion 45D.

In the present embodiment, for example, the user can install an unused liquid container 5 into the cartridge 1 using the following procedure. First, the user fixes the liquid container 5 in the case 3. Next, the user fixes the lid 4 onto the case 3 into which the liquid container 5 has been fixed. The cartridge 1 housing the liquid container 5 is thus completed. Hereinafter, with reference to FIG. 9 to FIG. 13, the procedure to install the liquid container 5 in the cartridge 1 will be explained in detail.

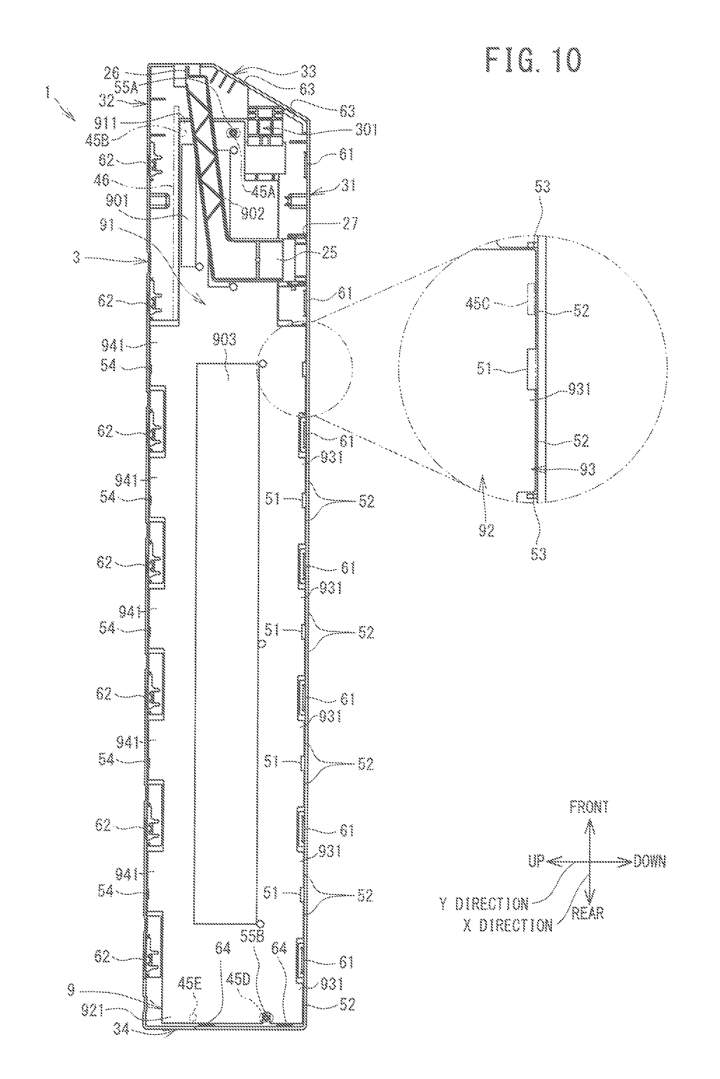

The procedure for fixing the liquid container 5 in the case 3 will be explained with reference to FIG. 9 and FIG. 10. The user moves the remaining amount detection plate 25 to the left so that the remaining amount detection plate 25 separates from the right wall 30 (refer to FIG. 5 and FIG. 6). Next, the user moves the liquid container 5 from the upper left side of the case 3 to a position between the placement surface 30A and the remaining amount detection plate 25. The attachment surface 9F (refer to FIG. 4) of the plate 9 thus faces the placement surface 30A (refer to FIG. 6) and the stopper 8 faces the stopper placement portion 301.

At that time, the user causes the lower end portion 9C (refer to FIG. 3) of the plate 9 to approach the lower end portion of the placement surface 30A and disposes the plurality of first convex portions 931 to the right of the respectively corresponding lower tab portions 51. As a result, each of the first convex portions 931 is sandwiched between the corresponding tab portion 51 and the placement surface 30A and engages with the corresponding tab portion 51. Further, the lower end portion of each of the first convex portions 931 having the length L1 (refer to FIG. 3) comes into contact with the corresponding two ribs 52, from above. The lower end portion of the first convex portion 931 having the length L2 (refer to FIG. 3) comes into contact with the corresponding single rib 52, from above. The first convex portion 931 furthermost to the front is disposed between the pair of ribs 53.

Next, in the state in which each of the first convex portions 931 is engaged with each of the lower tab portions 51, the user causes the upper end portion 9D (refer to FIG. 3) of the plate 9 to approach the upper end portion of the placement surface 30A. At this time, the user causes each of the second convex portions 941 to engage with the corresponding upper tab portion 54 in the following manner. First, the user causes the second convex portions 941 to come into contact with the protrusions 543 (refer to FIG. 7) from the left and presses the upper end portion 9D toward the placement surface 30A (refer to FIG. 6). Thus, the second convex portions 941 slide to the right on the inclined surfaces of the protrusions 543. As a result, the second convex portions 941 urge the protrusions 543 upward, and the arm portions 542 (refer to FIG. 7) are thus elastically deformed upward. When the second convex portions 941 slide as far as the right side of the protrusions 543, the second convex portions 941 are disposed on the placement surface 30A. At that time, the elastic deformation of the arm portions 542 is released, and the protrusions 543 move downward as far as the left side of the second convex portions 941. Thus, the second convex portions 941 are sandwiched between the protrusions 543 and the placement surface 30A, and engage with the upper tab portions 54.

Further, after the user has caused all the second convex portions 941 to respectively engage with the corresponding upper tab portions 54, the user inserts the pins 55A and 55B of the case 3 into the first hole 98A and the second hole 98B (refer to FIG. 2) of the plate 9, respectively. As a result, the stopper 8 is mounted in the stopper placement portion 301, and the rubber plug 84 (refer to FIG. 4) is exposed to the front via the stopper opening 333 (refer to FIG. 5). The pair of ribs 53 determine the position of the first convex portion 931 closest to the stopper placement portion 301. Thus, the position of the stopper 8 with respect to the stopper placement portion 301 can be accurately determined.

The liquid container 5 is fixed to the case 3 in the above-described manner, in a state in which the attachment surface 9F and the placement surface 30A are in surface contact with each other. Finally, the user causes the remaining amount detection plate 25 to come into contact with the sheet 72 (refer to FIG. 4), from the left. The remaining amount detection plate 25 is maintained in the state of contact with the sheet 72 by the elastic force of the torsion spring (not shown in the drawings). The remaining amount detection plate 25 is on the opposite side to the plate 9, with the reservoir portion 74 sandwiched therebetween, and extends through a position at which it overlaps with the first plate portion 91 in the Z direction. The remaining amount detection plate 25 extends upward, to the rear of the stopper communication portion 75, and moreover, extends further to the front than the first protrusion portion 911. Thus, at least a part of the remaining amount detection plate 25 is in a position separated, to the left, from the first protrusion portion 911.

The exposed portion 26 is exposed to the front via the exposure opening 334 (refer to FIG. 5). As described above, the length of the reservoir portion 74 in the Z direction changes in accordance with the remaining amount of the white ink stored inside. The position of the remaining amount detection plate 25 changes in the Z direction, in accordance with the changes in the length of the reservoir portion 74 in the Z direction. Thus, the position of the exposed portion 26 also changes in the Z direction. The user can ascertain the remaining amount of the ink in the liquid container 5 by verifying the position of the exposed portion 26 in the Z direction, via the exposure opening 334. Note that the printer 100 (refer to FIG. 1) may be provided with an optical sensor that detects the position of the exposed portion 26 in the Z direction via the exposure opening 334. The printer 100 can ascertain the remaining amount of the ink in the liquid container 5 on the basis of a detection result of the optical sensor.

Since the remaining amount detection plate 25 comes into contact with the front-end side portion of the reservoir portion 74 from the left, the front-end side portion of the reservoir portion 74 has a large impact on the detection accuracy of the remaining amount of ink by the remaining amount detection plate 25. In the present embodiment, the bonding members 901 and 902 disposed on the first plate portion 91 come into contact with the front-end side portion of the reservoir portion 74. Further, the pair of ribs 53 regulate the movement in the X direction of the first convex portion 931 closest to the remaining amount detection plate 25. The movement in the X direction of the front-end side portion of the reservoir portion 74 can thus be regulated, and a negative impact on the detection accuracy of the remaining amount of ink can be suppressed.

As the remaining amount of ink in the reservoir portion 74 decreases, the distance between the sheets 71 and 72 (refer to FIG. 4) becomes smaller, and the sheets 71 and 72 warp easily. In the present embodiment, the relief portion 76 (refer to FIG. 2) disposed to the left of the cut-out portion 96 (refer to FIG. 3) is the portion that is not supported by the plate 9. Thus, when the remaining amount of ink in the reservoir portion 74 has decreased, the sheets 71 and 72 warp easily at the relief portion 76 that extends from the stopper communication portion 75. The ink inside the relief portion 76 is thus easily guided to the stopper communication portion 75, and it is possible to suppress the ink from being depleted in the vicinity of the stopper communication portion 75. Further, creases easily occur in the warped sheets 71 and 72. When the sheets 71 and 72 warp, the creases in the sheets 71 and 72 occur easily in the relief portion 76 that is not supported by the plate 9. Thus, even when the remaining amount of ink in the reservoir portion 74 has decreased, the creases occurring in the reservoir portion 74 can be caused to escape to the relief portion 76. As a result, the negative impact on the detection accuracy of the remaining amount of ink can be suppressed.

In addition, the position of the liquid container 5 fixed in the case 3 is determined in the following manner. The movement in the Z direction of the liquid container 5 as a whole is regulated by the plurality of lower tab portions 51 and the plurality of upper tab portions 54 respectively regulating the movement in the Z direction of the corresponding first convex portions 931 and second convex portions 941. Therefore, the movement in the Z direction of the reservoir portion 74 can be regulated, and the negative impact on the detection accuracy of the remaining amount of ink by the remaining amount detection plate 25 can thus be suppressed.

The plurality of ribs 52 regulate the movement in the Y direction of each of the corresponding first convex portions 931, thus regulating the movement in the Y direction of the liquid container 5 as a whole. Thus, the plurality of first convex portions 931 do not easily slip out from each of the corresponding lower tab portions 51, and it is thus possible to inhibit the fixed state of the plate 9 inside the main body 2 from being released. The pair of ribs 53 regulate the movement in the X direction of the first convex portion 931 furthermost to the front side, and thus regulate the movement in the X direction of the liquid container 5 as a whole. Thus, it is possible to inhibit creases occurring in sheets 71 and 72 as a result of movement in the X direction of the storage portion 7 inside the main body 2.

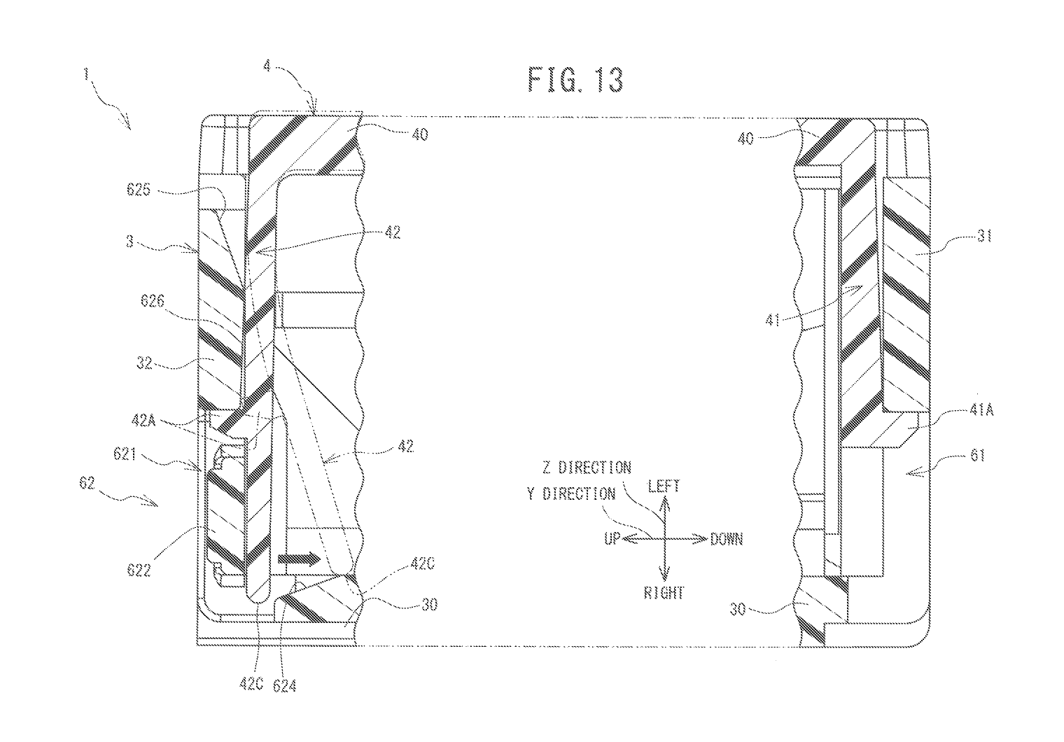

The procedure to fix the lid 4 on the case 3 in which the liquid container 5 is fixed will be explained with reference to FIG. 11 to FIG. 13. FIG. 13 shows a cross section of the cartridge 1 as seen in the direction of arrows along a line A-A shown in FIG. 5 and FIG. 12. As shown in FIG. 12, the line A-A passes through slightly to the front of the recessed portion 622B, of the rear-end side portion of the receiving plate 622.

As shown in FIG. 11, the user moves the upper end portion of the left wall 40 to the right, toward the top wall 32, in a state in which the right surface of the left wall 40 of the lid 4 faces the inside of the case 3, and the lower end portion of the left wall 40 is in contact with the left end portion of the bottom wall 31. At that time, the user causes the engagement tabs 41A (refer to FIG. 13) of the plurality of lower projecting pieces 41 to respectively engage with the corresponding lower engaging portions 61, inside the case 3. Further, inside the case 3, the user causes the pair of front projecting pieces 43 to engage respectively with the corresponding front engaging portions 63 and causes the pair of rear projecting pieces 44 to engage respectively with the corresponding rear engaging portions 64. In addition, each of the plurality of upper projecting pieces 42 is engaged with the corresponding upper engaging portion 62, in the following manner.

When the upper end portion of the left wall 40 is moved as far as the vicinity of the left end portion of the top wall 32, the inclined portions 42B of the upper projecting pieces 42 come into contact with the guide surfaces 625 (refer to FIG. 7 and FIG. 13) of the upper engaging portions 62. When the user moves the upper end portion of the left wall 40 further to the right, the inclined portions 42B slide along the guide surfaces 625. At that time, since the inclined portions 42B move gradually downward, the upper projecting pieces 42 gradually deflect downward. When the inclined portions 42B move to the right as far as a position past the guide surfaces 625, the engagement tabs 42A come into contact with the holding surfaces 626. When the user moves the upper end portion of the left wall 40 further to the right, the upper end portions of the engagement tabs 42A slide to the right while being in contact with the holding surfaces 626, and as a result of this, the projecting end portions 42C slide downward and to the left while being in contact with the inclined surfaces 624.

As shown in FIG. 12 and FIG. 13, when the upper end portions of the engagement tabs 42A slide to the right beyond the holding surfaces 626, the projecting end portions 42C slide to the left beyond the inclined surfaces 624. At this time, the upper end portions of the engagement tabs 42A can move to the openings 621 as a result of elastic force, and the upper engaging portions 62 thus return to the engaged state as a result of elastic force. The engagement tabs 42A enter into the openings 621 from the inside of the case 3. Thus, each of the engagement tabs 42A engages with the left edge portion of each of the openings 621. At that time, the top surfaces of the right-end side portions of the upper projecting pieces 42 face, in the Y direction, the bottom surfaces of the rear-end side portions of the receiving plates 622. The inclined surfaces 42B are disposed inside the recessed portions 622B. The projecting end portions 42C are disposed on the upper side of the inclined surfaces 624.

The lid 4 is fixed on the case 3n in this way, and the cartridge 1 in which the liquid container 5 is housed in the main body 2 is thus completed. Inside the cartridge 1, the liquid container 5 is placed on the right wall 30, and the left wall 40 faces the right wall 30 in the Z direction, with the liquid container 5 therebetween. In the present embodiment, the stopper communication portion 75 (refer to FIG. 9) that is disposed to the left of the cut-out portion 95 (refer to FIG. 3) is the portion that is not supported by the plate 9. Thus, the stopper communication portion 75 can be inhibited from being deformed by coming into contact with the plate 9. As a result, the white ink moving toward the front inside the reservoir portion 74 moves smoothly toward the stopper 8 via the stopper communication portion 75.

Further, as shown in FIG. 9 and FIG. 10, when the lid 4 is fixed to the case 3, the pressing portions 45A to 45E press the plate 9 from the left, and the support portion 46 supports a part of the storage portion 7 from the left. In FIG. 9 and FIG. 10, the pressing portions 45A to 45E and the support portion 46 are shown using two-dot chain lines.

As shown in FIG. 9, the pin 55A of the case 3 is inserted inside the pressing portion 45A, and the pressing portion 45A presses the first protrusion portion 911. The pressing portion 45B presses the upper end portion of the first protrusion portion 911 further above the pressing portion 45A. The remaining amount detection plate 25 extends while passing between the pressing portions 45A and 45B that press the first protrusion portion 911. The pin 55B of the case 3 is inserted inside the pressing portion 45D and the pressing portion 45D presses the second protrusion portion 921. The pressing portion 45E presses the second protrusion portion 921 further above the pressing portion 45D. Thus, inside the cartridge 1, both the end portions of the plate 9 in the X direction are pressed, and the liquid container 5 is thus more reliably fixed.

As shown in FIG. 10, the pressing portion 45C presses the first convex portion 931 furthermost to the front, between the front side rib 53 and the lower tab portion 51 furthermost to the front. Thus, inside the cartridge 1, both the end portions of the plate 9 in the Y direction are pressed, and the liquid container 5 is thus more reliably fixed. In addition, the pressing portions 45A to 45C press the plate 9 in the vicinity of the remaining amount detection plate 25. The movement of the front-end side portion of the reservoir portion 74, which has a large impact on the detection accuracy of the remaining amount of ink, can therefore be more reliably suppressed.

As shown in FIG. 9, the support portion 46 is disposed in a position facing the cut-out portion 97 (refer to FIG. 3) of the plate 9 in the Z direction and extends in the X direction. The support portion 46 faces the unsupported portion 77 of the storage portion 7 from the left. The unsupported portion 77 is the portion of the storage portion 7 that is not supported by the plate 9, and thus easily warps as a result of an external force, such as gravity and the like. For example, the left side of the unsupported portion 77 on the opposite side to the right wall 30 (refer to FIG. 11) easily warps. When the unsupported portion 77 warps, the length of the front-end side portion of the reservoir portion 74 in the Z direction changes. It is thus possible that the detection accuracy of the remaining amount of ink may deteriorate. In the present embodiment, the unsupported portion 77 is disposed between the support portion 46 and the right wall 30 in the Z direction. The support portion 46 regulates the warping of the unsupported portion 77, and the deterioration in the detection accuracy of the remaining amount of ink can thus be suppressed.

In the present embodiment, the user can remove the liquid container 5 that has been used, for example, from the cartridge 1 using the following procedure. The procedure to remove the liquid container 5 from the cartridge 1 will be explained in detail with reference to FIG. 11 to FIG. 13. In FIG. 13, the upper projecting pieces 42 that have elastically deformed are shown using two-dot chain lines.

First, the user releases the engaged state of each of the upper engaging portions 62 in the following manner. As shown in FIG. 12 and FIG. 13, the user presses the receiving plate 622 downward. In this way, the receiving plate 622 elastically deforms downward, centering around the front end portion of the receiving plate 622. At that time, the rear-end side portion of the receiving plate 622 comes into contact with the right-end side portion of the upper projecting piece 42 and causes the upper projecting piece 42 to elastically deform downward. Specifically, the upper projecting piece 42 is elastically deformed to the opposite side to the protrusion direction of the engagement tab 42A. In accordance with the elastic deformation of the upper projecting piece 42, the projecting end portion 42C slides downward and to the left along the inclined surface 624, and the engagement tab 42A moves downward from the inside of the opening portion 621.

As shown in FIG. 12, when the receiving plate 622 elastically deforms downward by a predetermined amount, the convex portion 622A comes into contact with the regulating portion 623, and the downward movement of the receiving plate 622 is thus regulated. At this time, as shown in FIG. 13, the engagement tab 42A retracts from the opening 621 and maintains a state of being in contact with the holding surface 626, slightly to the left of the opening 621. As a result, the state of the downward elastic deformation of the upper projecting piece 42 is maintained. More specifically, the projecting end portion 42C maintains a state of having moved far as the lower side of the inclined surface 624. In other words, by pressing the receiving plate 622, the user can release the engaged state of the upper projecting piece 42 and can maintain a disengaged state of the upper projecting piece 42.

Thus, instead of directly pressing the engagement tab 42A, the user can release the engaged state of the upper projecting piece 42 by pressing, in the Y direction, the receiving plate 622 that extends in the X direction and the Z direction. A surface area of the engagement tab 42A is smaller than a surface area of the receiving plate 622. Therefore, indirectly pressing the engagement tab 42A via the receiving plate 622 rather than directly pressing the engagement tab 42A results in a smaller load on the fingers etc. of the user. Further, when the engaged state of the upper projecting piece 42 is released, the disengaged state of the upper projecting piece 42 is maintained such that the engagement tab 42A does not easily re-enter the opening 621. In this way, simply by pressing the plurality of receiving plates 622 in order, the user can easily release the engaged state of all the upper projecting pieces 42.

As shown in FIG. 11, after the user has released the engaged state of all the upper projecting pieces 42, the user moves the upper end portion of the left wall 40 to the left away from the top wall 32, in a state in which the lower end portion of the left wall 40 is in contact with the left end portion of the bottom wall 31. At that time, the user removes the engagement tabs of the pair of front projecting pieces 43 from the respectively corresponding front engaging portions 63 and removes the engagement tabs of the pair of rear projecting portions 44 from the respectively corresponding rear engaging portions 64. After that, the user causes the lower end portion of the left wall 40 to separate from the left end portion of the bottom wall 31 and thus removes the engagement tabs 41A (refer to FIG. 13) of all the lower projecting pieces 41 from the respectively corresponding lower engaging portions 61. The lid 4 is removed from the case 3 in the above-described manner.

Next, the user releases the engaged state of each of the upper tab portions 54 in the following manner. As shown in FIG. 9, the user elastically deforms the arm portions 542 (refer to FIG. 7) upward, by pressing upward the inclined surfaces of the protrusions 543 (refer to FIG. 7) from inside the case 3. Thus, the protrusions 543 (refer to FIG. 7) are separated upward from the second convex portions 941. The user pulls the second convex portions 941 to the left away from the placement surface 30A (refer to FIG. 6), in the state in which the arm portions 542 are elastically deformed upward. The engaged state of the upper tab portions 54 is thus released.

After the engaged state of all the upper tab portions 54 has been released, the user moves the remaining amount detection plate 25 to the left away from the right wall 30 (refer to FIG. 5) and pulls out the liquid container 5 upward and to the left from inside the case 3. Thus, each of the first convex portions 931 is removed from between the corresponding lower tab portion 51 and the placement surface 30A, and the engaged state of all the lower tab portions 51 is thus released. As described above, the liquid container 5 is taken out of the case 3 and is removed from the cartridge 1. After the user has removed the liquid container 5 that has been used, for example, from the cartridge 1, the user can freely replace the liquid container 5 that is housed in the cartridge 1 by installing the unused liquid container 5 in the cartridge 1.

In the present embodiment, the plate 9 is provided with the first protrusion portion 911 and the second protrusion portion 921 that extend further than the storage portion 7 in the X direction. Therefore, the liquid container 5 does not easily warp in the X direction, and the user easily carries the liquid container 5 by grasping these protrusion portions. Further, the plate 9 is provided with the plurality of first convex portions 931 and the plurality of second convex portions 941 that extend further than the storage portion 7 in the Y direction. Therefore, the liquid container 5 does not easily warp in both the X direction and the Y direction, and the user more easily carries the liquid container 5 by grasping these convex portions. Thus, the user can smoothly perform the operation to install and remove the liquid container 5 into and from the case 3. Note that the white ink easily settles to the lower end portion of the reservoir portion 74 as a result of gravity and the like. Before fixing the liquid container 5 in the case 5, for example, the user can agitate the white ink inside the reservoir portion 74 by shaking the liquid container 5 while grasping the first protrusion portion 911 and the second protrusion portion 921.

As described above, the present embodiment discloses the liquid container 5 that is provided with the storage portion 7, the stopper 8, and the plate 9. The storage portion 7 is the flexible member storing the liquid. The storage portion 7 includes the surface 71A extending in the X direction and the Y direction that intersect the Z direction. The stopper 8 is provided in the front end portion 7A, of the front end portion 7A and the rear end portion 7B that are the two end portions of the storage portion 7 in the X direction. The plate 9 is fixed to the surface 71A. The front end portion 9A, which is one of the end portions of the plate 9 in the X direction, includes the first protrusion portion 911. The first protrusion portion 911 protrudes to the front away from the storage portion 7 in the X direction. Thus, since the plate 9 can support the front end portion 7A in the X direction of the storage portion 7, the liquid container 5 does not easily warp in the X direction. Further, the operator may easily carry the liquid container 5, using the first protrusion portion 911.

Note that, in the present embodiment, the rear end portion 9B that is the other end portion of the plate 9 in the X direction includes the second protrusion portion 921. The second protrusion portion 921 protrudes to the rear away from the storage portion 7 in the X direction. In other words, the first protrusion portion 911 and the second protrusion portion 921 protrude away from the storage portion 7 in both directions in the X direction. Thus, since the plate 9 can support the front end portion 7A and the rear end portion 7B of the storage portion 7 in the X direction, warping of the liquid container 5 in the X direction of the storage portion 7 may be even more reliably suppressed. Further, the operator may even more easily carry the liquid container 5, using the first protrusion portion 911 and the second protrusion portion 921.

The front end portion 9A of the plate 9 includes the first plate portion 91. The first plate portion 91 includes the first protrusion portion 911 that protrudes further to the front than the front end portion 7A. The first plate portion 91 is provided in a position separated from the stopper 8 in the Y direction. Specifically, the first plate portion 91 that includes the first protrusion portion 911 is separated from the stopper 8 in the Y direction. Thus, during an operation to fix the plate 9 and the storage portion 7 to each other, for example, the plate 9 and the stopper 8 do not easily interfere with each other. Further, since the first protrusion portion 911 protrudes further to the front than the front end portion 7A, the warping of the storage portion 7 on the stopper 8 side does not easily occur.

The storage portion 7 includes the stopper communication portion 75. The stopper communication portion 75 is the portion that is communicated with the stopper 8 provided in the front end portion 7A. The first plate portion 91 is provided in the position separated from the stopper communication portion 75 in the Y direction. Specifically, even if the stopper communication portion 75 has an expanded shape so as to pass the liquid toward the stopper 8, the first plate portion 91 is separated from the stopper communication portion 75 in the Y direction. Thus, the plate 9 and the stopper communication portion 75 do not easily interfere with each other.

The plate 9 includes the cut-out portion 96. The relief portion 76 extends toward the rear end portion 7B from the stopper communication portion 75, at the lower end portion of the storage portion 7 in the Y direction. The cut-out portion 96 exposes the relief portion 76 to the right toward the plate 9 from the storage portion 7 in the Z direction. In other words, even when the relief portion 76 has an expanded shape in order to cause the liquid to pass toward the stopper communication portion 75, the plate 9 does not support the relief portion 76 facing the cut-out portion 96 in the Z direction. Thus, the plate 9 and the relief portion 76 do not easily interfere with each other. Further, the wrinkles occurring in the storage portion 7 may be caused to escape to the relief portion 76 that extends from the stopper communication portion 75.

The stopper 8 is provided in the position closer to the lower end portion 7C than the upper end portion 7D, of the lower end portion 7C and the upper end portion 7D that are both the ends of the storage portion 7 in the Y direction. The first protrusion portion 911 protrudes further to the front than the front end portion 7A, between the stopper 8 and the upper end portion 7D. Thus, since the first protrusion portion 911 can be made longer in the Y direction, the first plate portion 91 may support the front end portion 7A in a more stable manner.

The first protrusion portion 911 has the first hole 98A that penetrates the first protrusion portion 911. In other words, the storage portion 7 does not cover the first hole 98A when the plate 9 is fixed appropriately to the storage portion 7. Thus, the operator manufacturing the liquid container 5 may accurately determine the position of the plate 9 in relation to the storage portion 7, using the first hole 98A as a reference. Further, the pin 55A is inserted into the first hole 98A when the liquid container 5 is housed in the case 3. Thus, the liquid container 5 may be fixed to the case 3 in a stable manner.

At the predetermined position in the X direction, the first hole 98A is aligned with respect to the stopper 8 in the Y direction. Thus, the operator manufacturing the liquid container 5 may accurately determine the position of the plate 9 in relation to the storage portion 7, by arranging the first hole 98A and the stopper 8 so as to be aligned with each other in the Y direction.

The first hole 98A is provided between the central portion, in the Y direction, of the first protrusion portion 911 and the stopper 8. Thus, the operator manufacturing the liquid container 5 may accurately determine the position of the plate 9 in relation to the storage portion 7, by arranging the stopper 8 on the side closer to the first hole 98A, of both sides of the first protrusion portion 911 in the Y direction. Thus, the position of the plate 9 may be accurately determined in relation to the storage portion 7.

The plate 9 is bonded to the surface 71A, using the bonding members 901 to 903, in the area over which the plate 9 overlaps with the surface 71A of the storage portion 7. The plate 9 has the indicator holes 99A to 99G. The indicator holes 99A to 99G are positioning markers showing the area that is the target for arranging the bonding members 901 to 903. Thus, the operator manufacturing the liquid container 5 may arrange the bonding members 901 to 903 in accurate positions, on the basis of the indicator holes 99A to 99G. The indicator holes 99A to 99G of the present embodiment are holes formed in the plate 9 and are thus easily provided in the plate 9.

The stopper 8 is provided in the position closer to the lower end portion 7C than the upper end portion 7D, of the lower end portion 7C and the upper end portion 7D that are both the ends of the storage portion 7 in the Y direction. The lower end portion 9C that is the one end portion of the plate 9 in the Y direction includes the first convex portions 931. The first convex portions 931 protrude downward so as to separate further from the storage portion 7 than the lower end portion 7C in the Y direction. In other words, since the first convex portions 931 protrude so as to separate further from the storage portion 7 than the lower end portion 7C in the Y direction, the plate 9 can support the lower end portion 7C of the storage portion 7. Thus, the liquid container 5 does not easily warp in the Y direction, and, in particular, the lower end portion 7C that is in the position close to the stopper 8 does not easily warp. Further, the operator may easily carry the liquid container 5 using the first convex portions 931.

The lower end portion 9C of the plate 9 includes the plurality of first convex portions 931. Thus, the lower end portion 7C of the storage portion 7 can be supported in a more stable manner by the plurality of first convex portions 931. Further, the operator may more easily carry the liquid container 5 using the plurality of first convex portions 931.

The upper end portion 9D that is the other end portion of the plate 9 in the Y direction includes the second convex portions 941. The second convex portions 941 protrude upward so as to separate further from the storage portion 7 than the upper end portion 7D in the Y direction. In other words, the first convex portions 931 and the second convex portions 941 protrude in both directions away from the storage portion 7 in the Y direction. Thus, the plate 9 can support the lower end portion 7C and the upper end portion 7D that are both the end portions of the storage portion 7 in the Y direction, and may more reliably suppress the warping of the storage portion 7 in the Y direction. Further, the operator may even more easily carry the liquid container 5 using the first convex portions 931 and the second convex portions 941.

The first convex portions 931 and the second convex portions 941 have mutually different lengths in the X direction. Thus, the operator manufacturing the liquid container 5 may accurately fix the plate 9 in relation to the storage portion 7 in the Y direction, on the basis of the first convex portions 931 and the second convex portions 941 having the mutually different lengths in the X direction.

The liquid stored in the storage portion 7 is the white ink. Thus, when the liquid inside the storage portion 7 is the white ink that is prone to sedimentation, the operator may agitate the white ink inside the storage portion 7 by shaking the liquid container 5 while grasping the first protrusion portion 911 and the like.

In addition, the present embodiment discloses the cartridge 1 configured to house the liquid container 5. The cartridge 1 is provided with the lower tab portions 51 and the upper tab portions 54. The lower tab portions 51 are configured to engage with the first convex portions 931 of the liquid container 5 housed in the cartridge 1. The upper tab portions 54 are configured to engage with the second convex portions 941 of the liquid container 5 housed in the cartridge 1. The upper tab portions 54 are configured to deform elastically. The upper tab portions 54 may be configured to deform elastically to the opposite side to the plate 9 of the liquid container 5 housed in the cartridge 1.

Specifically, the first convex portions 931 and the second convex portions 941 of the liquid container 5 housed in the cartridge 1 respectively engage with the lower tab portions 51 and the upper tab portions 54 of the cartridge 1. Thus, the liquid container 5 may be fixed inside the cartridge 1 in a stable manner. Further, the elastically deformable upper tab portions 54 may easily release the engaged state of each of the first convex portions 931 and the second convex portions 941. Thus, the liquid container 5 is easily inserted into and removed from the cartridge 1.

The cartridge 1 is provided with the two ribs 53. The two ribs 53 are provided on both sides, in the X direction, of the first convex portion 931 of the liquid container 5 housed in the cartridge 1, so as to sandwich the first convex portion 931. Specifically, the first convex portion 931 of the liquid container 5 housed in the cartridge 1 is arranged between the two ribs 53, in the X direction. Thus, the movement of the liquid container 5 may be regulated in the X direction.

The cartridge 1 is provided with the ribs 52 between the two ribs 53. The ribs 52 face, in the Y direction, the protruding ends of the first convex portions 931 of the liquid container 5 housed in the cartridge 1. Thus, the ribs 52 facing the protruding ends of the first convex portions 931 of the liquid container 5 housed in the cartridge 1 may regulate the movement of the liquid container 5 in the Y direction.

Further, when resin molding the case 3, rounded tapered portions sometimes occur at the corner portions connecting the placement surface 30A and the bottom wall 31. At this time, when the liquid container 5 is housed in the case 3, the first convex portions 931 ride up onto the tapered portions. There is thus a possibility that the position of the plate 9 in the Y direction cannot be accurately determined. In the present embodiment, the ribs 52 are provided at the corner portions connecting the placement surface 30A and the bottom wall 31. Thus, the position in the Y direction of the plate 9 housed in the case 3 can be accurately determined.

The cartridge 1 is provided with the remaining amount detection plate 25. The remaining amount detection plate 25 comes into contact with the storage portion 7 of the liquid container 5 housed in the cartridge 1, from the opposite side to the plate 9, and indicates the remaining amount of the liquid by moving in the Z direction. At least the one part of the remaining amount detection plate 25 is in the position that is separated, in the Z direction, from the first protrusion portion 911. Specifically, the remaining amount detection plate 25 comes into contact with the storage portion 7 from the opposite side to the plate 9, and at least the part of the remaining amount detection plate 25 is separated, in the Z direction, from the first protrusion portion 911. Thus, the remaining amount detection plate 25 moving in the Z direction may be inhibited from coming into contact with the plate 9, and the remaining amount detection plate 25 may accurately detect the remaining amount of liquid.

The cartridge 1 is provided with the case 3 and the lid 4. The case 3 includes the right wall 30, the top wall 32, and the openings 621. The liquid container 5 is placed on the right wall 30. The top wall 32 extends from the right wall 30 in the Z direction. The openings 621 penetrate the top wall 32 in the Y direction. The lid 4 has the left wall 40, the upper projecting pieces 42, and the engagement tabs 42A. The left wall 40 faces the right wall 30 in the Z direction, with the liquid container 5 sandwiched therebetween. The upper projecting pieces 42 protrude from the left wall 40 toward the right wall 30. The engagement tabs 42A protrude in the Y direction on the upper projecting pieces 42 and enter into the openings 621. The case 3 includes the inclined surfaces 624. The inclined surfaces 624 are provided in the positions facing the openings 621 in the Y direction, inside the case 3. The inclined surfaces 624 are inclined to the left from the right wall 30 toward the left wall 40, along the downward direction toward the inside of the case 3, from the openings 621. Thus, for example, when the projecting end portions 42C of the upper projecting pieces 42 can move along the inclined surfaces 624, the inclined surfaces 624 guide the engagement tabs 42A in the direction to retract from the openings 621.

When the upper projecting pieces 42 are elastically deformed to the opposite side to the protruding direction of the engagement tabs 42A, the inclined surfaces 624 guide the projecting end portions 42C of the upper projecting pieces 42 toward the inside of the case 3. When the inclined surfaces 624 guide the projecting end portions 42C, the engagement tabs 42A retract from the openings 621, and maintain the state of being in contact with the peripheral edges of the openings 621 in the top wall 32. Specifically, when the upper projecting pieces 42 are elastically deformed to the opposite side to the protruding direction of the engagement tabs 42A, the inclined surfaces 624 guide the projecting end portions 42C toward the inside of the case 3, and in accordance with this, the engagement tabs 42A retract from the openings 621. Thus, the engaged state of the lid 4 and the case 3 may be easily released. In addition, the engagement tabs 42A that have retracted from the openings 621 maintain the state of being in contact with the peripheral edges of the openings 621 in the top wall 32. Thus, the disengaged state of the lid 4 and the case 3 may be maintained.

The case 3 has the receiving plates 622. The receiving plates 622 are provided in the openings 621 in positions facing the upper projecting pieces 42 in the Y direction, and can swing in the Y direction. In other words, the user or the like may elastically deform the upper projecting pieces 42 to the opposite side to the protruding direction of the engagement tabs 42A by manipulating the receiving plates 622. Thus, the engaged state of the lid 4 and the case 3 may be easily released.

The receiving plates 622 extend in the X direction on the inside of the openings 621. The length of the receiving plates 622 in the X direction is greater than the length of the openings 621 in the Z direction. In other words, since the length of the receiving plates 622 in the X direction is greater than the length of the openings 621 in the Z direction, a movable range of the receiving plates 622 in the Y direction may be increased. Thus, the upper projecting pieces 42 may elastically deform in the Y direction as far as a position at which the engagement tabs 42A are reliably retracted from the inside of the openings 621.

The present disclosure is not limited to the above-described embodiment and various modifications are possible. The liquid stored inside the liquid container 5 may be color ink, or a liquid other than ink. It is sufficient that the longitudinal direction and the lateral direction of the storage portion 7 be directions that intersect a predetermined direction. The stopper 8 may be provided in a central portion, in the Y direction, of the front end portion 7A or the rear end portion 7B of the storage portion 7, or may be provided in the lower end portion 7C or the upper end portion 7D. Thus, the plate 9 is not limited to the above-described embodiment and the following modifications are possible, for example.

It is sufficient that the plate 9 be provided with at least one of the first protrusion portion 911 and the second protrusion portion 921. The respective positions, shapes, and number of the first protrusion portion 911 and the second protrusion portion 921 are not limited to the above-described embodiment and can be modified. When the stopper 8 is provided in the central portion, in the Y direction, of the front end portion 7A, it is sufficient that the first protrusion portion 911 protrude further than the front end portion 7A in at least one direction of both sides of the stopper 8 in the Z direction. The plate 9 need not necessarily be provided with the plurality of first convex portions 931 and the plurality of second convex portions 941, or at least one of the plurality of first convex portions 931 and the plurality of second convex portions 941 may be provided. The respective numbers, shapes, and positions of the first convex portions 931 and the second convex portions 941 are not limited to the above-described embodiment and can be modified. For example, the same number of the first convex portions 931 and the second convex portions 941 may be provided at the same positions as each other in the X direction.

The plate 9 need not necessarily be provided with the first hole 98A, or a plurality of the first holes 98A may be provided in the first protrusion portion 911. When the plate 9 is not provided with the first hole 98A, the case 3 does not require the pin 55A. The plate 9 need not necessarily be provided with the second hole 98B, or a plurality of the second holes 98B may be provided in the second protrusion portion 921. When the plate 9 is not provided with the second hole 98B, the case 3 does not require the pin 55B. The respective shapes and positions of the first hole 98A and the second hole 98B are not limited to the above-described embodiment and can be modified. Instead of bonding the storage portion 7 and the plate 9 using the three bonding members 901 to 903, they may be bonded using another number of bonding members or may be bonded by a bonding member having a shape other than the rectangular shape. The plate 9 need not necessarily be provided with the indicator holes 99A to 99G. In this case, the plate 9 may be provided, for example, with a position determination marker obtained by printing a line, a graphic or the like that indicates an area that is the target for arranging the bonding member.

The case 3 need not necessarily be provided with at least one of the plurality of lower tab portions 51, the plurality of ribs 52, the pair of ribs 53, and the plurality of upper tab portions 54. The respective positions, shapes, and numbers of the plurality of lower tab portions 51, the plurality of ribs 52, the pair of ribs 53, and the plurality of upper tab portions 54 are not limited to the above-described embodiment and can be modified. For example, the pair of ribs 53 may be provided so as to correspond to all of the first convex portions 931. It is sufficient that at least one of the plurality of upper tab portions 54 and the plurality of lower tab portions 51 be able to swing in the Y direction as a result of elastic deformation.

The lid 4 need not necessarily be provided with at least one of the plurality of lower projecting pieces 41, the plurality of upper projecting pieces 42, the pair of front projecting pieces 43, and the pair of rear projecting pieces 44. The case 3 need not necessarily be provided with at least one of the plurality of lower engaging portions 61, the plurality of upper engaging portions 62, the pair of front engaging portions 63, and the pair of rear engaging portions 64. The upper engaging portions 62 are not limited to the above-described embodiment. For example, the upper engaging portions 62 need not necessarily be provided with the inclined surfaces 624 and need not necessarily be provided with the receiving plates 622. The receiving plates 622 may be a plate shape that is long in the Z direction, for example.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A liquid container comprising:
a storage portion that is a flexible member storing a liquid, the storage portion including a surface extending in a longitudinal direction and a lateral direction, the longitudinal direction and the lateral direction intersecting a predetermined direction;
a stopper provided in a first end portion of the storage portion, of the first end portion and a second end portion that are both end portions in the longitudinal direction of the storage portion; and
a plate fixed to the surface, at least one of both end portions of the plate in the longitudinal direction including a protrusion portion, the protrusion portion protruding in a separating direction, of the longitudinal direction, in which the protrusion portion separates from the storage portion.

2. The liquid container according to claim 1, wherein
at least one of both the end portions of the plate in the longitudinal direction includes a plate end portion, the plate end portion including the protrusion portion that protrudes further in the separating direction than the first end portion, and
the plate end portion is provided in a position separated, in the lateral direction, from the stopper.

3. The liquid container according to claim 2, wherein
the storage portion includes a stopper communication portion that is communicated with the stopper provided in the first end portion, and
the plate end portion is provided in a position separated, in the lateral direction, from the stopper communication portion.

4. The liquid container according to claim 3, wherein
the plate includes a cut-out portion that exposes a section of the storage portion in a direction toward the plate from the storage portion, of the predetermined direction, the section being a section extending toward the second end portion from the stopper communication portion, at one end portion in the lateral direction of the storage portion.

5. The liquid container according to claim 2, wherein
of a third end portion and a fourth end portion that are both end portions in the lateral direction of the storage portion, the stopper is provided in a position closer to the third end portion than the fourth end portion, and
the protrusion portion protrudes further in the separating direction than the first end portion, between the stopper and the fourth end portion.

6. The liquid container according to claim 5, wherein
the protrusion portion includes a hole penetrating the protrusion portion.

7. The liquid container according to claim 6, wherein
the hole is provided, in the lateral direction, between a central portion in the lateral direction of the protrusion portion and the stopper.

8. The liquid container according to claim 1, wherein
in an area in which the plate overlaps with the surface of the storage portion, the plate is bonded to the surface, using a bonding member, and
the plate includes a position determination marker indicating an area in which the bonding member is to be disposed.

9. The liquid container according to claim 1, wherein
of a third end portion and a fourth end portion that are both end portions in the lateral direction of the storage portion, the stopper is provided in a position closer to the third end portion than the fourth end portion, and
a one end portion in the lateral direction of the plate includes a first convex portion, the first convex portion protruding further than the third end portion in a direction away from the storage portion, of the lateral direction.

10. The liquid container according to claim 9, wherein
the one end portion in the lateral direction of the plate includes a plurality of the first convex portions.

11. The liquid container according to claim 9, wherein
another end portion in the lateral direction of the plate includes a second convex portion, the second convex portion protruding further than the fourth end portion in a direction away from the storage portion, of the lateral direction.

12. The liquid container according to claim 11, wherein
the first convex portion and the second convex portion have mutually different lengths in the longitudinal direction.

13. A cartridge configured to house the liquid container according to claim 11, the cartridge comprising:
a first tab portion configured to engage with the first convex portion of the liquid container housed in the cartridge; and
a second tab portion configured to engage with the second convex portion of the liquid container housed in the cartridge,
wherein
at least one of the first tab portion and the second tab portion is configured to elastically deform.

14. The cartridge according to claim 13, further comprising:
two first ribs provided on both sides, in the longitudinal direction, of the first convex portion so as to sandwich the first convex portion of the liquid container housed in the cartridge.

15. The cartridge according to claim 14, further comprising:
a second rib provided between the two first ribs, the second rib facing, in the lateral direction, a protruding end of the first convex portion of the liquid container housed in the cartridge.

16. The cartridge according to claim 15, further comprising:
a remaining amount detection plate that indicates a remaining amount of the liquid, the remaining amount detection plate coming into contact with the storage portion of the liquid container housed in the cartridge from the opposite side to the plate and indicating the remaining amount by moving in the predetermined direction, at least a part of the remaining amount detection plate being disposed so as to be separated, in the predetermined direction, from the protrusion portion.

17. The cartridge according to claim 13, further comprising:
a case including a first wall, a second wall, and an opening portion, the liquid container being placed on the first wall, the second wall extending in the predetermined direction from the first wall, the opening portion penetrating the second wall in the lateral direction; and
a lid including a third wall, a protrusion piece, and an engagement tab, the third wall facing the first wall in the predetermined direction in a state in which the liquid storage portion is disposed between the first wall and the third wall, the protrusion piece protruding from the third wall toward the first wall, the engagement tab protruding in the lateral direction, on the protrusion piece, and entering into the opening portion,
wherein
the case includes an inclined surface provided in a position facing the opening portion in the lateral direction, inside the case, the inclined surface following a direction from the opening portion toward the inside of the case, of the lateral direction, and being inclined in a direction from the first wall toward the third wall, of the predetermined direction.

18. The cartridge according to claim 17, wherein
when the protrusion piece is elastically deformed to the opposite side to a protruding direction of the engagement tab, the inclined surface guides a protruding end portion of the protrusion piece toward the inside of the case, and
when the protruding end portion is guided by the inclined surface, the engagement tab retracts from the opening portion and maintains a state of being in contact with a peripheral edge of the opening portion in the second wall.

19. The cartridge according to claim 17, wherein
the case includes a receiving plate provided in a position facing the protrusion piece in the lateral direction, in the opening portion, the receiving plate being configured to swing in the lateral direction.

20. The cartridge according to claim 19, wherein
the receiving plate extends in the longitudinal direction inside the opening portion, and
a length in the longitudinal direction of the receiving plate is greater than a length in the predetermined direction of the opening portion.
